(19) United States
(12) Patent Application Publication
(10) Pub. No.: US 2017/0144906 A1
(43) Pub. Date: May 25, 2017

(54) SYSTEMS AND METHODS FOR TREATMENT OF WATER, SUCH AS OILFIELD WASTEWATER, VIA CHEMICAL COAGULATION

(71) Applicant: Gradiant Corporation, Woburn, MA (US)

(72) Inventors: Jonn-Ross Andrews, Somerville, MA (US); Prakash Narayan Govindan, Melrose, MA (US); Maximus G. St. John, Boston, MA (US); Steven Lam, Medford, MA (US)

(73) Assignee: Gradiant Corporation, Woburn, MA (US)

(21) Appl. No.: 15/364,785

(22) Filed: Nov. 30, 2016

Related U.S. Application Data
(63) Continuation-in-part of application No. PCT/US2016/050803, filed on Sep. 8, 2016.
(60) Provisional application No. 62/215,717, filed on Sep. 8, 2015.

(51) Int. Cl. C02F 1/52; C02F 1/04; C02F 1/56

(52) U.S. Cl. CPC C02F 1/5245; C02F 1/56; C02F 1/04; C02F 1/5236; C02F 2001/007

(57) ABSTRACT

Described herein are systems and methods for treating an aqueous input stream comprising at least one suspended and/or emulsified immiscible phase (e.g., oil, grease) and, in some cases, one or more additional contaminants, such as solubilized bicarbonate (HCO₃⁻) ions, solubilized divalent cations (e.g., Ca²⁺, Mg²⁺), solubilized trivalent cations (e.g., Fe³⁺, Al³⁺), organic material (e.g., humic acid, fulvic acid), hydrogen sulfide (H₂S), and/or suspended solids. According to certain embodiments, the aqueous feed stream is supplied to a water treatment system comprising a chemical coagulation apparatus and a suspended solids removal apparatus (e.g., a clarifier). Within the chemical coagulation apparatus, an amount of an inorganic coagulant (e.g., aluminum chlorohydrate, polyaluminum chloride), an amount of a strong base (e.g., sodium hydroxide), and an amount of a polyelectrolyte (e.g., polyacrylamide) may be added to the aqueous input stream to form a chemically-treated stream. In some embodiments, the inorganic coagulant, strong base, and/or polyelectrolyte may induce coagulation and/or flocculation of at least a portion of the contaminants within the aqueous input stream, and the chemically-treated stream may comprise a plurality of flocs (i.e., particle agglomerates). In some embodiments, the chemically-treated stream is directed to flow to the suspended solids removal apparatus. Within the suspended solids removal apparatus, a plurality of flocs may be removed from the chemically-treated stream to form a contaminant-diminished stream having a lower concentration of contaminants than the aqueous input stream. In some embodiments, the chemically-treated stream and the contaminant-diminished stream each have a pH of about 8 or less. In some embodiments, the chemically-treated stream and the contaminant-diminished stream each have a temperature of about 15° C. or less.

### RELATED APPLICATIONS

This application is a continuation-in-part of International Application No. PCT/US2016/050803, filed Sep. 8, 2016, and entitled “Systems and Methods for Treatment of Water, Such as Oilfield Wastewater, Via Chemical Coagulation,” which claims priority under 35 U.S.C. §119(e) to U.S. Provisional Patent Application No. 62/215,717, filed Sep. 8, 2015, and entitled “Systems and Methods for Treatment of Water, Such as Oilfield Wastewater, Via Chemical Coagulation,” each of which is incorporated herein by reference in its entirety for all purposes.

### TECHNICAL FIELD

Systems and methods for the treatment of water, with particular utility for oilfield wastewater, are generally described.

### BACKGROUND

Extraction of oil and/or gas from subterranean reservoirs often produces large volumes of contaminated wastewater (i.e., produced water) as a byproduct. In some cases, it may be desirable to treat the oilfield wastewater to remove one or more contaminants in order to render it suitable for human and/or animal consumption, irrigation, industrial use, and/or use in oil or gas extraction operations (e.g., as a drilling fluid and/or hydraulic fracturing fluid). In certain cases, it may be desirable to treat the produced water to comply with government regulations relating to wastewater disposal.

Conventional methods for treating water, including conventional coagulation methods, are often expensive and/or poorly suited for treating oilfield wastewater. For example, the presence of hydrocarbons and/or bicarbonates in the wastewater may interfere with conventional treatment methods. Accordingly, improved systems and methods for treating oilfield wastewater are needed.

### SUMMARY

Systems and methods for the treatment of oilfield wastewater are generally described. The subject matter of the present invention involves, in some cases, interrelated products, alternative solutions to a particular problem, and/or a plurality of different uses of one or more systems and/or articles.

Certain embodiments relate to methods for treating water. In some embodiments, a method for treating water comprises supplying an aqueous input stream comprising at least one suspended and/or emulsified immiscible phase to a chemical coagulation apparatus. In some embodiments, the method further comprises adding, within the chemical coagulation apparatus, an amount of an inorganic coagulant, an amount of a strong base, and an amount of a polyelectrolyte to the aqueous input stream to form a chemically-treated stream. In certain embodiments, the method further comprises flowing the chemically-treated stream to a suspended solids removal apparatus configured to remove at least a portion of suspended solids from the chemically-treated stream to form a contaminant-diminished stream. According to some embodiments, each of the chemically-treated stream and the contaminant-diminished stream has a pH of about 8 or less.

In some embodiments, a method for treating water comprises supplying an aqueous input stream comprising at least one suspended and/or emulsified immiscible phase to a chemical coagulation apparatus. In some embodiments, the method further comprises adding, within the chemical coagulation apparatus, an amount of an inorganic coagulant, an amount of a strong base, and an amount of a polyelectrolyte to the aqueous input stream to form a chemically-treated stream. In certain cases, the method further comprises flowing the chemically-treated stream to a suspended solids removal apparatus configured to remove at least a portion of suspended solids from the chemically-treated stream to form a contaminant-diminished stream. According to some embodiments, each of the chemically-treated stream and the contaminant-diminished stream has a temperature of about 15° C. or less.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1A is a schematic diagram of an exemplary water treatment system comprising a chemical coagulation apparatus and a suspended solids removal apparatus, according to some embodiments;

FIG. 1B is a schematic diagram of an exemplary water treatment system comprising a chemical coagulation apparatus, a suspended solids removal apparatus, and a solids-handling apparatus, according to some embodiments;

FIG. 1C is a schematic diagram of an exemplary water treatment system comprising a chemical coagulation apparatus comprising three reaction vessels, a suspended solids removal apparatus, and a solids-handling apparatus, according to some embodiments;

FIG. 2 is, according to some embodiments, a schematic diagram of an exemplary water treatment system comprising a chemical coagulation apparatus, a suspended solids removal apparatus, a solids-handling apparatus, and a desalination system;

FIG. 3 is a schematic illustration of an exemplary humidification-dehumidification desalination system, according to some embodiments; and

FIG. 4 is, according to some embodiments, a schematic diagram of an exemplary water treatment system comprising a chemical coagulation apparatus, a suspended solids removal apparatus, a solids-handling apparatus, a generator, and a heat exchanger.

### DETAILED DESCRIPTION

Described herein are systems and methods for treating an aqueous input stream comprising at least one suspended and/or emulsified immiscible phase (e.g., oil, grease) and, in some cases, one or more additional contaminants, such as solubilized bicarbonate (HCO₃⁻) ions, solubilized divalent cations (e.g., Ca²⁺, Mg²⁺), solubilized trivalent cations (e.g., Fe³⁺, Al³⁺), organic material (e.g., humic acid, fulvic acid), hydrogen sulfide (H₂S), and/or suspended solids. According to certain embodiments, the aqueous input stream is supplied to a water treatment system comprising a chemical coagulation apparatus and a suspended solids removal apparatus (e.g., a clarifier). Within the chemical coagulation apparatus, an amount of an inorganic coagulant (e.g., aluminum chlorohydrate, polyaluminum chloride), an amount of a strong base (e.g., sodium hydroxide), and an amount of a polyelectrolyte (e.g., anionic polyacrylamide) may be added to the aqueous input stream to form a chemically-treated stream. In some embodiments, the inorganic coagulant, strong base, and/or polyelectrolyte may induce coagulation and/or flocculation of at least a portion of the contaminants within the aqueous input stream, and the chemically-treated stream may comprise a plurality of flocs (i.e., particle agglomerates). In some embodiments, the chemically-treated stream is directed to flow to the suspended solids removal apparatus. Within the suspended solids removal apparatus, at least a portion of the plurality of flocs may be removed from the chemically-treated stream to form a contaminant-diminished stream having a lower concentration of contaminants than the aqueous input stream. In some embodiments, the chemically-treated stream and the contaminant-diminished stream each have a pH of about 8 or less. In certain embodiments, the chemically-treated stream and the contaminant-diminished stream each have a temperature of about 15° C. or less.

In some cases, at least a portion of the contaminants present in a wastewater stream are colloidal particles (i.e., particles having an average size between 1 nanometer and 100 micrometers). Colloidal particles may be challenging to remove from wastewater streams via filtration due to their small size, and instead they are often removed through methods involving coagulation (i.e., destabilization of a colloidal dispersion) and flocculation (i.e., agglomeration of particles, such as destabilized colloidal particles). However, oilfield wastewater streams may pose challenges to conventional coagulation methods due to the presence of certain contaminants in the streams. For example, oilfield wastewater streams often comprise oil and grease, which may interfere with certain chemical reactions that conventional chemical coagulation methods rely upon. In addition, some oilfield wastewater streams comprise solubilized bicarbonate ions, which may have a buffering effect that may reduce the efficacy of certain conventional chemical coagulation methods. Further, the relatively low specific gravity of oil and grease may promote the formation of floating flocs, which are generally more difficult to remove than settling flocs.

It has unexpectedly been determined within the context of this invention that systems and methods described herein can be used to cheaply and effectively treat oilfield wastewater to remove at least a portion of one or more contaminants. In particular, it has been determined that adding an inorganic coagulant, a strong base, and a polyelectrolyte to an oilfield wastewater stream within a chemical coagulation apparatus can result in the formation of settling flocs (e.g., fast-settling flocs) that can be removed to form a contaminant-diminished stream. Further, certain systems and methods described herein may promote coagulation and flocculation of at least a portion of the contaminants within an oilfield wastewater stream without increasing the pH of the stream above about 8. In some cases, this may advantageously avoid the need to add an acid downstream to neutralize the pH of the stream, thereby reducing chemical costs. In addition, certain systems and methods described herein may be effective over a wide range of temperatures. In some cases, certain systems and methods described herein may promote coagulation and flocculation of at least a portion of the contaminants within an oilfield wastewater stream at a temperature at or below about 15° C. In some cases, this may advantageously avoid the expense of heating the wastewater stream. In addition, the systems and methods described herein may be associated with other advantages compared to conventional coagulation methods, including, but not limited to, the production of relatively small amounts of sludge, which may reduce disposal costs.

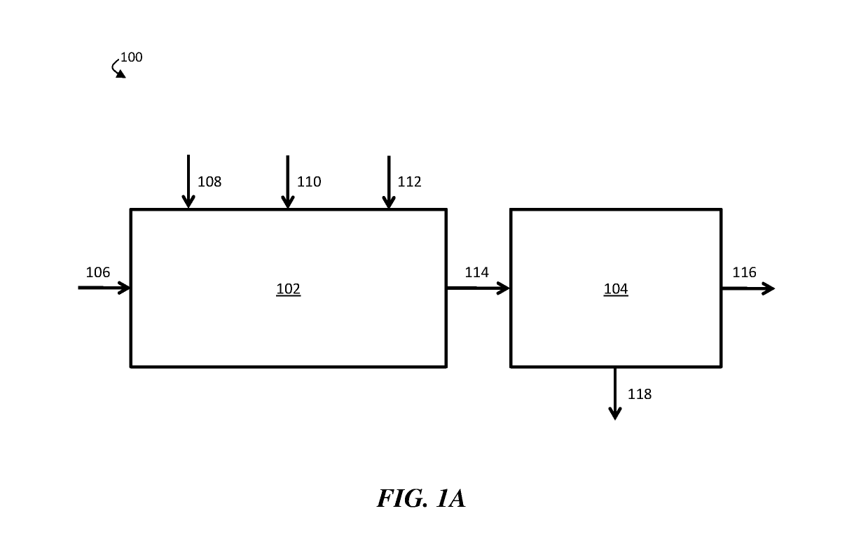

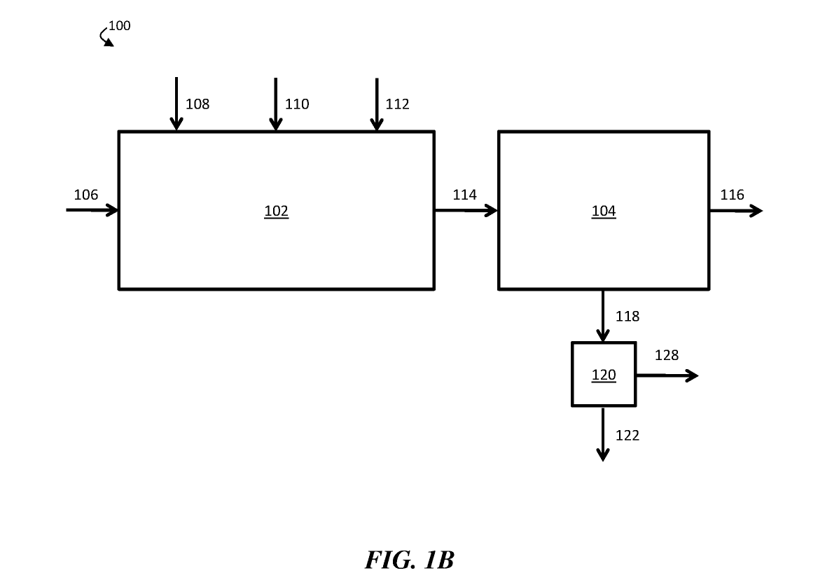

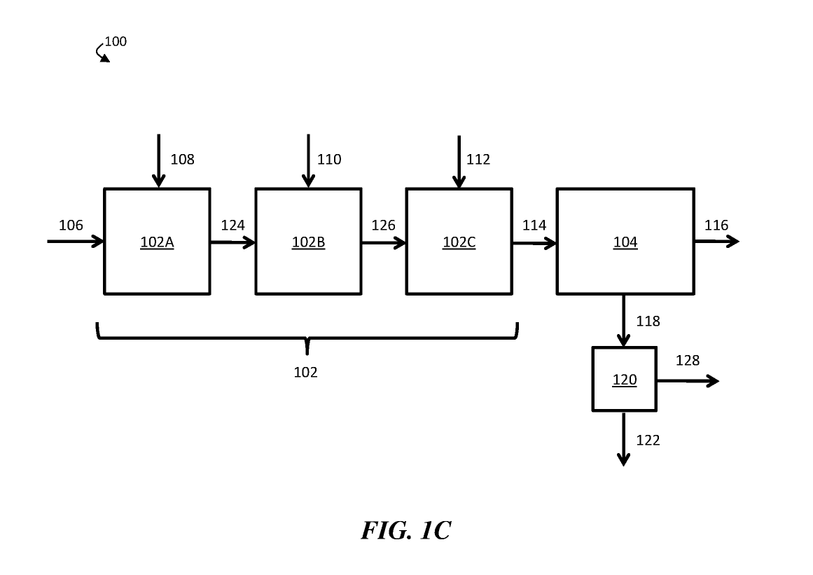

FIG. 1A is a schematic diagram of an exemplary water treatment system, according to some embodiments. In certain embodiments, a water treatment system comprises a chemical coagulation apparatus configured to add one or more chemicals to a volume of liquid (e.g., an aqueous input stream). For example, as shown in FIG. 1A, water treatment system 100 comprises chemical coagulation apparatus 102. In some embodiments, the water treatment system further comprises a suspended solids removal apparatus fluidically connected to the chemical coagulation apparatus. In FIG. 1A, for example, water treatment system 100 further comprises suspended solids removal apparatus 104 fluidically connected to chemical coagulation apparatus 102.

In operation, aqueous input stream 106, which comprises one or more contaminants, including at least one suspended and/or emulsified immiscible phase, may be supplied to chemical coagulation apparatus 102. In chemical coagulation apparatus 102, an amount of an inorganic coagulant 108, an amount of a strong base 110, and an amount of a polyelectrolyte 112 may be added to aqueous input stream 106 to form chemically-treated stream 114. In some embodiments, inorganic coagulant 108, strong base 110, and/or polyelectrolyte 112 may induce coagulation and/or flocculation of one or more contaminants within aqueous input stream 106, and chemically-treated stream 114 may comprise one or more flocs comprising at least a portion of the one or more contaminants.

Chemically-treated stream 114 may then be directed to flow from chemical coagulation apparatus 102 to suspended solids removal apparatus 104. Within suspended solids removal apparatus 104, at least a portion of the one or more contaminants may further coagulate and/or flocculate. In some embodiments, a plurality of flocs (e.g., flocs formed within chemical coagulation apparatus 102 and/or suspended solids removal apparatus 104) may be removed from chemically-treated stream 114, thereby forming contaminant-diminished stream 116. For example, a plurality of flocs may sink to the bottom of suspended solids removal apparatus 104, where they may be removed from chemically-treated stream 114. In some embodiments, the plurality of flocs may exit suspended solids removal apparatus 104 as solids-containing stream 118. In some cases, contaminant-diminished stream 116, the portion of chemically-treated stream 114 that remains after removal of the plurality of flocs, may have a lower concentration of the one or more contaminants than aqueous input stream 106.

In certain embodiments, a suspended solids removal apparatus is fluidically connected to an optional solids-handling apparatus (e.g., a dewatering apparatus). For example, in FIG. 1B, suspended solids removal apparatus 104 is fluidically connected to optional solids-handling apparatus 120. In operation, solids-containing stream 118 (e.g., a stream comprising sludge formed by settled flocs) may be directed to flow from suspended solids removal apparatus 104 to optional solids-handling apparatus 120. In some embodiments, solids-handling apparatus 120 may at least partially separate the solid phase and liquid phase of solids-containing stream 118 and form filter cake 122 and filtered liquid stream 128.

According to some embodiments, a chemical coagulation apparatus comprises one or more reaction vessels (e.g., reaction tanks). In some embodiments, each reaction vessel may be configured to add one or more chemicals to a volume of liquid (e.g., an aqueous input stream). In certain embodiments, for example, chemical coagulation apparatus 102 comprises a single reaction vessel. In embodiments in which chemical coagulation apparatus 102 comprises a single reaction vessel, the reaction vessel may be configured to add three different chemicals (e.g., inorganic coagulant 108, strong base 110, and polyelectrolyte 112) to aqueous input stream 106. In some embodiments, the single reaction vessel comprises an agitator.

In some embodiments, a chemical coagulation apparatus comprises two or more reaction vessels. For example, FIG. 1C shows a schematic diagram of an exemplary water treatment system in which a chemical coagulation apparatus comprises three separate reaction vessels. In FIG. 1C, chemical coagulation apparatus 102 comprises first reaction vessel 102A, second reaction vessel 102B, and third reaction vessel 102C. Each of reaction vessels 102A, 102B, and 102C optionally comprises an agitator. As shown in FIG. 1C, third reaction vessel 102C is fluidically connected to suspended solids removal apparatus 104.

In operation, aqueous input stream 106 enters first reaction vessel 102A of chemical coagulation apparatus 102. In first reaction vessel 102A, an amount of inorganic coagulant 108 may be added to aqueous input stream 106 to form first intermediate stream 124. In some embodiments, first reaction vessel 102A comprises an agitator (e.g., a fast-rotating, high-shear agitator), and inorganic coagulant 108 may be mixed with aqueous input stream 106 at a relatively high shear rate.

First intermediate stream 124 may then be directed to flow to second reaction vessel 102B of chemical coagulation apparatus 102. In second reaction vessel 102B, an amount of strong base 110 may be added to first intermediate stream 124 to form second intermediate stream 126.

Second intermediate stream 126 may then be directed to flow to third reaction vessel 102C of chemical coagulation apparatus 102. In third reaction vessel 102C, an amount of polyelectrolyte 112 may be added to second intermediate stream 126 to form chemically-treated stream 114. In some embodiments, third reaction vessel 102C comprises an agitator (e.g., a slowly-rotating, low-shear agitator). In certain embodiments, conditions within third reaction vessel 102C are selected to promote floc formation and existence. For example, polyelectrolyte 112 and second intermediate stream 126 may be mixed by an agitator at a low shear rate to facilitate distribution of polyelectrolyte 112 in stream 126 without breaking up existing flocs. In some embodiments, low-shear mixing may cause at least some particles and/or flocs within stream 126 to collide and adhere to each other, resulting in the formation of larger flocs.

Chemically-treated stream 114, which may comprise a plurality of flocs, may then be directed to flow from third reaction vessel 102C to suspended solids removal apparatus 104. In suspended solids removal apparatus 104, at least a portion of the plurality of flocs may be removed, exiting suspended solids removal apparatus 104 as solids-containing stream 118, while the remainder of chemically-treated stream 114 may exit suspended solids removal apparatus 104 as contaminant-diminished stream 116. In certain embodiments, solids-containing stream 118 may be directed to flow to optional solids-handling apparatus 120, which may produce filter cake 122 (e.g., a substantially solid cake comprising at least a portion of the one or more contaminants) and filtered liquid stream 128.

Although FIG. 1C illustrates a water treatment system in which an inorganic coagulant is added first, a strong base is added second, and a polyelectrolyte is added third, it should be noted that the inorganic coagulant, strong base, and polyelectrolyte may be added in any other order.

According to some embodiments, a chemical coagulation apparatus comprises at least one reaction vessel configured to add an amount of an inorganic coagulant to a volume of liquid (e.g., an aqueous input stream). In some embodiments, the inorganic coagulant comprises an inorganic polymer. An inorganic polymer may refer to a polymer (e.g., a molecule comprising a plurality of repeat units) with a backbone that does not comprise carbon atoms. In some embodiments, the inorganic polymer is a cationic polymer. In certain cases, the inorganic coagulant comprises a plurality of monomers, oligomers, and/or polymers. In some embodiments, the inorganic coagulant comprises an inorganic salt. An inorganic salt may refer to an ionic compound that does not comprise carbon atoms. In certain embodiments, the inorganic coagulant (e.g., an inorganic polymer, an inorganic salt) is substantially soluble in and/or miscible with the aqueous stream to which it is being added.

In some embodiments, the inorganic coagulant comprises aluminum. In some such embodiments, the inorganic coagulant may be referred to as an aluminum-based inorganic coagulant. According to certain embodiments, the inorganic coagulant may comprise a compound having the chemical formula AlₙCl₍₃ₙ₋ₘ₎(OH)ₘ. In some embodiments, the inorganic coagulant comprises aluminum chlorohydrate (“ACH”). In certain cases, aluminum chlorohydrate comprises compounds having the chemical formula Al₂(OH)₅Cl. In some embodiments, the inorganic coagulant comprises polyaluminum chloride (“PACl”). In certain cases, polyaluminum chloride comprises compounds having the chemical formula Al₂(OH)₃Cl₃. In certain embodiments, it may be desirable to use an aluminum-based inorganic coagulant instead of an iron-based inorganic coagulant in order to avoid increasing the concentration of dissolved iron cations in the aqueous stream.

In some embodiments, the aluminum-based inorganic coagulant has a relatively high basicity. Basicity of an aluminum-based inorganic coagulant, as used herein, is determined by dividing the number of hydroxyl ions by three times the number of aluminum ions in the inorganic coagulant. For example, in a compound having the chemical formula AlₙCl₍₃ₙ₋ₘ₎(OH)ₘ, basicity is calculated using the following formula: m/(3n). Basicity may, accordingly, provide a measure of how many hydroxyl ions are included in an inorganic coagulant. In embodiments in which the inorganic coagulant comprises an inorganic polymer, the basicity of the inorganic coagulant may be obtained by determining the basicity of the pre-polymerized coagulant.

In some embodiments, the aluminum-based inorganic coagulant has a basicity of at least about 50%, at least about 60%, at least about 70%, at least about 75%, at least about 80%, at least about 85%, at least about 90%, or at least about 95%. In certain embodiments, the aluminum-based inorganic coagulant has a basicity in the range of about 50% to about 80%, about 50% to about 85%, about 50% to about 90%, about 50% to about 95%, about 60% to about 80%, about 60% to about 85%, about 60% to about 90%, about 60% to about 95%, about 70% to about 80%, about 70% to about 85%, about 70% to about 90%, about 70% to about 95%, about 80% to about 85%, about 80% to about 90%, about 80% to about 95%, about 85% to about 90%, or about 85% to about 95%.

In some embodiments, the aluminum-based inorganic coagulant has a relatively high concentration of aluminum. As used herein, the concentration of aluminum in an aluminum-based inorganic coagulant refers to the weight of aluminum in the coagulant divided by the total weight of the coagulant, as determined from the chemical formula of the coagulant. In some embodiments, the aluminum-based inorganic coagulant has an aluminum concentration of at least about 5% w/w, at least about 6% w/w, at least about 7% w/w, at least about 8% w/w, at least about 9% w/w, at least about 10% w/w, at least about 15% w/w, or at least about 20% w/w. In some embodiments, the aluminum-based inorganic coagulant has an aluminum concentration in the range of about 5% to about 10% w/w, about 5% to about 15% w/w, about 5% to about 20% w/w, about 6% to about 10% w/w, about 6% to about 15% w/w, about 6% to about 20% w/w, about 7% to about 10% w/w, about 7% to about 15% w/w, about 7% to about 20% w/w, about 8% to about 10% w/w, about 8% to about 15% w/w, about 8% to about 20% w/w, about 9% to about 15% w/w, about 9% to about 20% w/w, about 10% to about 15% w/w, about 10% to about 20% w/w, or about 15% to about 20% w/w.

In some embodiments, the inorganic coagulant comprises iron. A non-limiting example of a suitable iron-based inorganic coagulant is polyferric sulfate. In some embodiments, polyferric sulfate has the chemical formula [Fe₂(OH)ₙ(SO₄)_{3-n/2}]ₓ. In certain cases, n is less than 2, and x is greater than 10.

In some embodiments, the iron-based inorganic coagulant has a relatively high basicity. In some embodiments, the iron-based inorganic coagulant has a basicity of at least about 50%, at least about 60%, at least about 70%, at least about 75%, at least about 80%, at least about 85%, at least about 90%, or at least about 95%. In certain embodiments, the iron-based inorganic coagulant has a basicity in the range of about 50% to about 80%, about 50% to about 85%, about 50% to about 90%, about 50% to about 95%, about 60% to about 80%, about 60% to about 85%, about 60% to about 90%, about 60% to about 95%, about 70% to about 80%, about 70% to about 85%, about 70% to about 90%, about 70% to about 95%, about 80% to about 85%, about 80% to about 90%, about 80% to about 95%, about 85% to about 90%, or about 85% to about 95%.

In some embodiments, the iron-based inorganic coagulant has a relatively high iron concentration. As used herein, the concentration of iron in an iron-based inorganic coagulant refers to the weight of iron in the coagulant divided by the total weight of the coagulant, as determined from the chemical formula of the coagulant. In some embodiments, the iron-based inorganic coagulant has an iron concentration of at least about 5% w/w, at least about 6% w/w, at least about 7% w/w, at least about 8% w/w, at least about 9% w/w, at least about 10% w/w, at least about 15% w/w, or at least about 20% w/w. In some embodiments, the iron-based inorganic coagulant has an iron concentration in the range of about 5% to about 10% w/w, about 5% to about 15% w/w, about 5% to about 20% w/w, about 6% to about 10% w/w, about 6% to about 15% w/w, about 6% to about 20% w/w, about 7% to about 10% w/w, about 7% to about 15% w/w, about 7% to about 20% w/w, about 8% to about 10% w/w, about 8% to about 15% w/w, about 8% to about 20% w/w, about 9% to about 15% w/w, about 9% to about 20% w/w, about 10% to about 15% w/w, about 10% to about 20% w/w, or about 15% to about 20% w/w.

In some embodiments, the inorganic coagulant (e.g., an aluminum-based inorganic coagulant or an iron-based inorganic coagulant) has a relatively high molecular weight. In cases in which the inorganic coagulant comprises a polymer, the molecular weight of the coagulant as used herein refers to the number average molecular weight Mₙ. Number average molecular weight may be obtained by taking the number average of the molecular weights of individual polymer molecules, according to the following formula:

$${M}_{n} = \frac{\sum {M}_{i} {N}_{i}}{\sum {N}_{i}} \qquad ( 1 )$$

where Nᵢ is the number of molecules of molecular weight Mᵢ. The number average molecular weight described herein refers to that which would be obtained by use of gel permeation chromatography.

In some cases, the inorganic coagulant has a number average molecular weight of at least about 200 g/mol, at least about 300 g/mol, at least about 400 g/mol, at least about 500 g/mol, at least about 600 g/mol, at least about 700 g/mol, at least about 800 g/mol, at least about 900 g/mol, or at least about 1000 g/mol. In some embodiments, the inorganic coagulant has a number average molecular weight in the range of about 200 g/mol to about 300 g/mol, about 200 g/mol to about 400 g/mol, about 200 g/mol to about 500 g/mol, about 200 g/mol to about 600 g/mol, about 200 g/mol to about 700 g/mol, about 200 g/mol to about 800 g/mol, about 200 g/mol to about 900 g/mol, or about 200 g/mol to about 1000 g/mol.

In some embodiments, the inorganic coagulant has a relatively high density. In certain cases, a relatively high density may advantageously promote formation of floc that is heavy enough to settle rather than float (e.g., in an aqueous stream). In some embodiments, the inorganic coagulant has a certain density at a reference temperature of about 25° C. In some embodiments, the inorganic coagulant has a density of at least about 9 pounds/gallon, at least about 9.5 pounds/gallon, at least about 10 pounds/gallon, at least about 10.5 pounds/gallon, at least about 11 pounds/gallon, at least about 11.5 pounds/gallon, at least about 12 pounds/gallon, at least about 12.5 pounds/gallon, at least about 13 pounds/gallon, at least about 13.5 pounds/gallon, or at least about 14 pounds/gallon at a reference temperature of about 25° C. In some embodiments, the inorganic coagulant has a density in the range of about 9 pounds/gallon to about 10 pounds/gallon, about 9 pounds/gallon to about 11 pounds/gallon, about 9 pounds/gallon to about 12 pounds/gallon, about 9 pounds/gallon to about 13 pounds/gallon, about 9 pounds/gallon to about 14 pounds/gallon, about 10 pounds/gallon to about 11 pounds/gallon, about 10 pounds/gallon to about 12 pounds/gallon, about 10 pounds/gallon to about 13 pounds/gallon, about 10 pounds/gallon to about 14 pounds/gallon, about 11 pounds/gallon to about 12 pounds/gallon, about 11 pounds/gallon to about 13 pounds/gallon, about 11 pounds/gallon to about 14 pounds/gallon, about 12 pounds/gallon to about 13 pounds/gallon, about 12 pounds/gallon to about 14 pounds/gallon, or about 13 pounds/gallon to about 14 pounds/gallon at a reference temperature of about 25° C.

In some embodiments, the inorganic coagulant has a relatively high specific gravity. As used herein, the specific gravity of an inorganic coagulant refers to the ratio of the density of the inorganic coagulant to the density of water at a reference temperature of about 25° C. In some embodiments, the inorganic coagulant has a specific gravity of at least about 1.0, at least about 1.01, at least about 1.02, at least about 1.03, at least about 1.04, at least about 1.05, at least about 1.05, at least about 1.06, at least about 1.07, at least about 1.08, at least about 1.09, at least about 1.1, at least about 1.2, at least about 1.3, at least about 1.4, or at least about 1.5 at a reference temperature of about 25° C. In some embodiments, the inorganic coagulant has a specific gravity in the range of about 1.0 to about 1.5, about 1.01 to about 1.5, about 1.03 to about 1.5, about 1.05 to about 1.5, about 1.07 to about 1.5, about 1.1 to about 1.5, about 1.2 to about 1.5, about 1.3 to about 1.5, or about 1.4 to about 1.5 at a reference temperature of about 25° C.

Without wishing to be bound by a particular theory, addition of an amount of the inorganic coagulant to an aqueous stream (e.g., aqueous input stream) comprising one or more contaminants may induce coagulation by neutralizing negative colloidal surface charge. For example, the aqueous stream may comprise a plurality of colloidal particles having a negative surface charge, and the inorganic coagulant may reduce the repulsive force between the colloidal particles and bring the solution closer to the isoelectric point (i.e., the point at which the zeta potential is zero). At or near the isoelectric point, flocs may be easily formed with a minimum amount of kinetic energy, which may be imparted to the colloidal particles through mixing.

In some embodiments, addition of an amount of the inorganic coagulant to an aqueous stream (e.g., aqueous input stream) comprising one or more contaminants may also induce coagulation through bridging. Bridging generally refers to a polymer being adsorbed to two or more particles (e.g., colloidal particles) and, accordingly, acting as a bridge connecting the two or more particles. In some cases, an inorganic coagulant having a relatively high molecular weight (e.g., a number average molecular weight of at least about 1000 g/mol) may advantageously facilitate bridging.

In some embodiments, a relatively small amount of the inorganic coagulant is added to an aqueous stream (e.g., aqueous input stream). In some embodiments, the amount of the inorganic coagulant added is about 250 mg/L or less, about 200 mg/L or less, about 100 mg/L or less, about 50 mg/L or less, about 20 mg/L or less, about 15 mg/L or less, about 12 mg/L or less, about 10 mg/L or less, about 5 mg/L or less, or about 1 mg/L or less. In some embodiments, the amount of the inorganic coagulant added is in the range of about 1 mg/L to about 5 mg/L, about 1 mg/L to about 10 mg/L, about 1 mg/L to about 12 mg/L, about 1 mg/L to about 15 mg/L, about 1 mg/L to about 20 mg/L, about 1 mg/L to about 50 mg/L, about 1 mg/L to about 100 mg/L, about 1 mg/L to about 200 mg/L, or about 1 mg/L to about 250 mg/L.

In some embodiments, addition of the inorganic coagulant to an aqueous stream (e.g., aqueous input stream) may change (e.g., reduce) the pH of the aqueous stream by a relatively small amount. In some cases, for example, addition of the inorganic coagulant to the aqueous stream may change (e.g., reduce) the pH of the aqueous stream by about 1.0 or less, about 0.8 or less, about 0.6 or less, about 0.4 or less, about 0.2 or less, or about 0.1 or less. In some embodiments, addition of the inorganic coagulant may change (e.g., reduce) the pH of the aqueous stream by an amount in the range of about 0.1 to about 0.2, about 0.1 to about 0.4, or about 0.1 to about 0.6, about 0.1 to about 0.8, or about 0.1 to about 1.0. In some cases, it may be advantageous to avoid significant change (e.g., reduction) of pH upon addition of the inorganic coagulant in order to avoid the need to add additional chemicals (e.g., bases) downstream to neutralize the pH of the aqueous stream.

In some embodiments, the inorganic coagulant may be added directly to the aqueous stream (e.g., aqueous input stream) without upstream addition of an acid (e.g., to reduce the pH of the aqueous stream). In some embodiments, the inorganic coagulant may be added to an aqueous stream having a pH of at least about 6.5, at least about 7.0, at least about 7.5, at least about 8.0, at least about 8.5, at least about 9.0, at least about 9.5, or at least about 10.0. In some embodiments, the inorganic coagulant is added to an aqueous stream having a pH in the range of about 6.5 to about 7.0, about 6.5 to about 7.5, about 6.5 to about 8.0, about 6.5 to about 8.5, about 6.5 to about 9.0, about 6.5 to about 9.5, about 6.5 to about 10.0, about 7.0 to about 7.5, about 7.0 to about 8.0, about 7.0 to about 8.5, about 7.0 to about 9.0, about 7.0 to about 9.5, about 7.0 to about 10.0, about 7.5 to about 8.0, about 7.5 to about 8.5, about 7.5 to about 9.0, about 7.5 to about 9.5, about 7.5 to about 10.0, about 8.0 to about 8.5, about 8.0 to about 9.0, about 8.0 to about 9.5, about 8.0 to about 10.0, about 8.5 to about 9.0, about 8.5 to about 9.5, about 8.5 to about 10.0, about 9.0 to about 9.5, or about 9.0 to about 10.0.

In some embodiments, the inorganic coagulant is mixed with the aqueous stream (e.g., aqueous input stream) at a relatively high shear rate. In some cases, mixing at a relatively high shear rate may impart kinetic energy to colloidal particles within the aqueous stream, allowing them to collide and overcome the energy barrier to aggregation. In some embodiments, the inorganic coagulant is mixed with the aqueous stream at a shear rate of at least about 390 s⁻¹, at least about 500 s⁻¹, at least about 600 s⁻¹, at least about 700 s⁻¹, at least about 900 s⁻¹, or at least about 1000 s⁻¹. In some embodiments, the inorganic coagulant is mixed with the aqueous stream at a shear rate in the range of about 390 s⁻¹ to about 500 s⁻¹, about 390 s⁻¹ to about 700 s⁻¹, about 390 s⁻¹ to about 900 s⁻¹, about 390 s⁻¹ to about 1000 s⁻¹, about 500 s⁻¹ to about 1000 s⁻¹, about 600 s⁻¹ to about 1000 s⁻¹, or about 700 s to about 1000 s⁻¹.

In some embodiments, the pH of an aqueous stream following addition of the inorganic coagulant is about 8 or less, about 7.8 or less, about 7.6 or less, about 7.5 or less, about 7.4 or less, about 7.2 or less, about 7 or less, about 6.8 or less, about 6.6 or less, or about 6.5 or less. In some embodiments, the pH of an aqueous stream following addition of the inorganic coagulant is in the range of about 6.5 to about 7.0, about 6.5 to about 7.5, about 6.5 to about 8.0, about 6.8 to about 8.0, about 7.0 to about 8.0, about 7.2 to about 8.0, about 7.4 to about 8.0, or about 7.6 to about 8.0.

According to some embodiments, the chemical coagulation apparatus is configured to add an amount of a strong base to an aqueous stream (e.g., aqueous input stream, first intermediate stream). A strong base generally refers to a chemical compound that is capable of deprotonating a very weak acid in an acid-base reaction. Non-limiting examples of suitable strong bases include sodium hydroxide (caustic soda), potassium hydroxide, calcium hydroxide (slaked lime), and/or calcium oxide (quicklime).

Without wishing to be bound by a particular theory, addition of the strong base to an aqueous stream (e.g., aqueous input stream, first intermediate stream) comprising one or more solubilized ions (e.g., solubilized bicarbonate ions, solubilized divalent cations) may induce precipitation of at least a portion of the ions as one or more insoluble solids. In some cases, for example, the strong base may react with solubilized bicarbonate ions and convert at least a portion of the solubilized bicarbonate ions into carbonate ions. In certain embodiments, the carbonate ions may react with solubilized divalent cations (e.g., Ca²⁺) in the aqueous stream to form certain insoluble solids, such as calcium carbonate (CaCO₃). In some embodiments, ions of the strong base (e.g., hydroxide ions from sodium hydroxide) may directly interact with certain ions (e.g., Ca²⁺, Mg²⁺) in the aqueous stream to form certain insoluble solids, such as calcium hydroxide (Ca(OH)₂) and/or magnesium hydroxide (Mg(OH)₂).

In some embodiments, one or more precipitated solids may have a higher density than the aqueous stream (e.g., aqueous input stream, first intermediate stream). In some embodiments, the formation of relatively high density solids may promote the formation of settling floc instead of floating floc. In some embodiments, one or more precipitated solids have a density of at least about 1.5 g/mL, at least about 2.0 g/mL, at least about 2.5 g/mL, at least about 3 g/mL, at least about 3.5 g/mL, at least about 4.0 g/mL, at least about 4.5 g/mL, or at least about 5 g/mL. In some embodiments, one or more precipitated solids have a density in the range of about 1.5 g/mL to about 5 g/mL, about 2 g/mL to about 5 g/mL, about 2.5 g/mL to about 5 g/mL, about 3 g/mL to about 5 g/mL, about 3.5 g/mL to about 5 g/mL, or about 4 g/mL to about 5 g/mL.

In some embodiments, the pH of an aqueous stream following addition of the strong base is about 8 or less, about 7.8 or less, about 7.6 or less, about 7.5 or less, about 7.4 or less, about 7.2 or less, about 7 or less, about 6.8 or less, about 6.6 or less, or about 6.5 or less. In some embodiments, the pH of an aqueous stream following addition of the strong base is in the range of about 6.5 to about 7.0, about 6.5 to about 7.5, about 6.5 to about 8.0, about 6.8 to about 8.0, about 7.0 to about 8.0, about 7.2 to about 8.0, about 7.4 to about 8.0, or about 7.6 to about 8.0. In some cases, it may be advantageous for the pH of a treated stream to be relatively low in order to avoid the need for a pH adjustment step at the end of the treatment process, which would increase costs. In some cases, it may also be advantageous to maintain a relatively low pH in order to ensure lower production of sludge.

In some embodiments, a relatively small amount of the strong base is added to the aqueous stream (e.g., aqueous input stream, first intermediate stream). In some embodiments, the amount of the strong base added is about 250 mg/L or less, about 200 mg/L or less, about 100 mg/L or less, about 50 mg/L or less, about 20 mg/L or less, about 15 mg/L or less, about 12 mg/L or less, about 10 mg/L or less, about 5 mg/L or less, or about 1 mg/L or less. In some embodiments, the amount of the strong base added is in the range of about 1 mg/L to about 5 mg/L, about 1 mg/L to about 10 mg/L, about 1 mg/L to about 12 mg/L, about 1 mg/L to about 15 mg/L, about 1 mg/L to about 20 mg/L, about 1 mg/L to about 50 mg/L, about 1 mg/L to about 100 mg/L, about 1 mg/L to about 200 mg/L, or about 1 mg/L to about 250 mg/L.

According to some embodiments, the chemical coagulation apparatus is configured to add an amount of a polyelectrolyte to an aqueous stream (e.g., aqueous input stream, first intermediate stream, second intermediate stream). A polyelectrolyte generally refers to a polymer comprising a plurality of repeat units that comprise an electrolyte group (i.e., a group that dissociates into a cation and an anion in an aqueous solution). Without wishing to be bound by a particular theory, addition of the polyelectrolyte to the aqueous stream may promote the formation of flocs through bridging.

In some embodiments, the polyelectrolyte comprises an anionic polymer (i.e., a polymer that has a negative charge after dissociation in solution). In some embodiments, the polyelectrolyte comprises a non-ionic polymer (i.e., a polymer that has a neutral charge after dissociation in solution).

In some embodiments, the polyelectrolyte is a homopolymer (i.e., a polymer comprising a single type of repeat unit). In certain embodiments, the polyelectrolyte is a copolymer (i.e., a polymer comprising two or more types of repeat units). In some such embodiments, the polyelectrolyte may be an alternative copolymer, a periodic copolymer, a statistic copolymer, a block copolymer, and/or a grafted copolymer.

In some embodiments, the polyelectrolyte comprises polyacrylamide (i.e., a polymer comprising a plurality of acrylamide repeat units). According to some embodiments, the polyelectrolyte comprises a non-ionic polyacrylamide. In certain embodiments, the non-ionic polyacrylamide is a homopolymer (e.g., comprising only polyacrylamide repeat units). According to some embodiments, the polyelectrolyte comprises an anionic polyacrylamide. In certain embodiments, the anionic polyacrylamide is a copolymer. In some embodiments, for example, the anionic polyacrylamide comprises acrylamide repeat units and one or more additional types of repeat units (e.g., acrylate repeat units).

In some embodiments, the polyelectrolyte has a relatively high molecular weight. In certain cases, the polyelectrolyte has a number average molecular weight of at least about 100,000 g/mol, at least about 500,000 g/mol, at least about 1,000,000 g/mol, at least about 2,000,000 g/mol, at least about 5,000,000 g/mol, at least about 10,000,000 g/mol, at least about 20,000,000 g/mol, or at least about 30,000,000 g/mol. In some embodiments, the polyelectrolyte has a number average molecular weight in the range of about 100,000 g/mol to about 500,000 g/mol, about 100,000 g/mol to about 1,000,000 g/mol, about 100,000 g/mol to about 2,000,000 g/mol, about 100,000 g/mol to about 5,000,000 g/mol, about 100,000 g/mol to about 10,000,000 g/mol, about 100,000 g/mol to about 20,000,000 g/mol, about 100,000 g/mol to about 30,000,000 g/mol, about 500,000 g/mol to about 1,000,000 g/mol, about 500,000 g/mol to about 2,000,000 g/mol, about 500,000 g/mol to about 5,000,000 g/mol, about 500,000 g/mol to about 10,000,000 g/mol, about 500,000 g/mol to about 20,000,000 g/mol, about 500,000 g/mol to about 30,000,000 g/mol, about 1,000,000 g/mol to about 2,000,000 g/mol, about 1,000,000 g/mol to about 5,000,000 g/mol, about 1,000,000 g/mol to about 10,000,000 g/mol, about 1,000,000 g/mol to about 20,000,000 g/mol, or about 1,000,000 g/mol to about 30,000,000 g/mol. In certain cases, a relatively high molecular weight polyelectrolyte may advantageously facilitate bridging of particles (e.g., colloidal particles).

In some embodiments, the polyelectrolyte is mixed with the aqueous stream at a relatively low shear rate. In some cases, low-shear mixing advantageously facilitates homogeneous distribution of the polyelectrolyte in the aqueous stream without breaking existing flocs. In some embodiments, the polyelectrolyte is mixed at a shear rate of about 390 s⁻¹ or less, about 300 s⁻¹ or less, about 200 s⁻¹ or less, about 100 s⁻¹ or less, about 75 s⁻¹ or less, about 50 s⁻¹ or less, about 25 s⁻¹ or less, or about 10 s⁻¹ or less. In some embodiments, the polyelectrolyte is mixed at a shear rate in the range of about 10 s⁻¹ to about 25 s⁻¹, about 10 s⁻¹ to about 50 s⁻¹, about 10 s⁻¹ to about 75 s⁻¹, about 10 s⁻¹ to about 100 s⁻¹, about 10 s⁻¹ to about 200 s⁻¹, about 10 s⁻¹ to about 300 s⁻¹, or about 10 s⁻¹ to about 390 s⁻¹.

In some embodiments, the pH of an aqueous stream following addition of the polyelectrolyte is about 8 or less, about 7.8 or less, about 7.6 or less, about 7.5 or less, about 7.4 or less, about 7.2 or less, about 7 or less, about 6.8 or less, about 6.6 or less, or about 6.5 or less. In some embodiments, the pH of an aqueous stream following addition of the polyelectrolyte is in the range of about 6.5 to about 7.0, about 6.5 to about 7.5, about 6.5 to about 8.0, about 6.8 to about 8.0, about 7.0 to about 8.0, about 7.2 to about 8.0, about 7.4 to about 8.0, or about 7.6 to about 8.0.

According to some embodiments, the water treatment system comprises a suspended solids removal apparatus fluidically connected to the chemical coagulation apparatus. In some embodiments, the suspended solids removal apparatus is configured to receive a chemically-treated stream from the chemical coagulation apparatus. In the suspended solids removal apparatus, at least a portion of suspended solids within the chemically-treated stream may be removed to form a contaminant-diminished stream. In some cases, the contaminant-diminished stream contains a lower concentration of contaminants than the aqueous input stream received by the chemical coagulation apparatus.

In some embodiments, the suspended solids removal apparatus is a gravity-based settling device. In certain embodiments, the gravity-based settling device is a clarifier. The clarifier can be configured such that at least a portion of floc within an aqueous stream in the clarifier (e.g., floc formed in the chemical coagulation apparatus) can settle within the clarifier.

In certain embodiments, the clarifier is a lamella clarifier (e.g., an inclined-plate clarifier). A lamella clarifier generally refers to a vessel comprising a plurality of inclined plates. In operation, an aqueous stream (e.g., a chemically-treated stream from the chemical coagulation apparatus) may enter the lamella clarifier, and floc within the aqueous stream may settle on one or more of the inclined plates of the lamella clarifier. In some cases, floc may begin to accumulate on the inclined plates, and as the weight of the accumulated flocs increases, the flocs may slide down the inclined plates to the bottom of the clarifier. In certain cases, collection hoppers may be located at the bottom of the clarifier, collecting the settling flocs as a solids-containing stream. In some cases, a sludge removal device (e.g., a sludge scraper) may scrape the bottom of the clarifier to remove sludge from the clarifier. In some embodiments, at least a portion of the removed sludge may exit the clarifier as part of the solids-containing stream. A clarified aqueous stream comprising fewer contaminants (e.g., a contaminant-diminished stream) may exit through the top of the clarifier. Non-limiting examples of suitable clarifiers include a Hydro-Flo ClariMax™ inclined plate clarifier and a Slant Plate Clarifier (M.W. Watermark).

In some cases, lamella clarifiers may be associated with certain advantages. For example, the inclined plates of a lamella clarifier may provide a relatively large settling area within a relatively small footprint. This may, for example, allow a lamella clarifier to have a smaller sludge removal device than certain other types of clarifiers. In some cases, use of a smaller sludge removal device may advantageously reduce costs associated with the clarifier. In addition, a lamella clarifier may have few, if any, moving parts, and there may therefore be a lower likelihood that any components would fail and disrupt operation of the clarifier.

Although the suspended solids removal apparatus has been described as a lamella clarifier, it should be noted that the suspended solids removal apparatus may be any other type of suspended solids removal apparatus known in the art. For example, the suspended solids removal apparatus may comprise a hydrocyclone (e.g., a de-oiling hydrocyclone), a corrugated plate interceptor, an adsorption media filter, a coalescing media filter, a membrane filter, an induced gas flotation (IGF) separator, and/or a skimmer.

In some embodiments, the suspended solids removal apparatus produces a relatively small amount of sludge (e.g., solids-containing stream). According to some embodiments, the suspended solids removal apparatus produces about 1 kg or less, about 0.8 kg or less, about 0.6 kg or less, about 0.4 kg or less, about 0.3 kg or less, about 0.25 kg or less, about 0.2 kg or less, or about 0.1 kg or less of the solids-containing stream per barrel produced of the contaminant-diminished stream. In some cases, it may be desirable to produce a relatively small amount of sludge to reduce disposal costs.

According to some embodiments, the suspended solids removal apparatus is fluidically connected to an optional solids-handling apparatus. The solids-handling apparatus may be configured, in certain embodiments, to remove at least a portion of the water retained by a solids-containing stream (e.g., sludge, settled flocs). In some such embodiments, the solids-handling apparatus is configured to produce a substantially solid cake. As one example, the solids-handling apparatus can comprise a filter (e.g., a vacuum filter or a filter press) configured to at least partially separate the solid phase and the liquid phase of a solids-containing stream. In some such embodiments, at least a portion of the liquid within the solids-containing stream can be transported through the filter, leaving behind insoluble solid. As one non-limiting example, a Larox FP 2016-8000 64/64 M40 PP/PP Filter (Outotech, Inc.) may be used as the filter. The filter may comprise, in certain embodiments, a conveyor filter belt. In some embodiments, the solids-handling apparatus comprises a centrifuge.

According to certain coagulation methods described herein, each step of the method (e.g., addition of an inorganic coagulant, addition of a strong base, addition of a polyelectrolyte) is conducted at a pH of about 8.0 or less. In some cases, conducting the steps at a pH of about 8.0 or less may avoid the need for a downstream pH adjustment step, which may require the addition of acid. Avoiding addition of acid may, for example, advantageously reduce costs associated with the described methods. Accordingly, in some embodiments, each of the chemically-treated stream(s) and the contaminant-diminished stream(s) (and, in certain embodiments, any intermediate streams) has a pH of about 8 or less, about 7.8 or less, about 7.6 or less, about 7.5 or less, about 7.4 or less, about 7.2 or less, about 7.0 or less, about 6.8 or less, about 6.6 or less, or about 6.5 or less. In some embodiments, each of the chemically-treated stream(s) and the contaminant-diminished stream(s) (and, in certain embodiments, any intermediate streams) has a pH in the range of about 6.5 to about 7.0, about 6.5 to about 7.5, about 6.5 to about 8.0, about 7.0 to about 7.5, about 7.0 to about 8.0, or about 7.5 to about 8.0.

In some embodiments, the aqueous input stream has a pH of about 8 or less, about 7.8 or less, about 7.6 or less, about 7.5 or less, about 7.4 or less, about 7.2 or less, about 7.0 or less, about 6.8 or less, about 6.6 or less, or about 6.5 or less. In some embodiments, the aqueous input stream has a pH in the range of about 6.5 to about 7.0, about 6.5 to about 7.5, about 6.5 to about 8.0, about 7.0 to about 7.5, about 7.0 to about 8.0, or about 7.5 to about 8.0.

Certain methods described herein can be conducted at relatively low temperatures. In some cases, such methods may advantageously avoid or reduce the costs associated with heating the aqueous input stream received by the chemical coagulation apparatus. In some embodiments, the chemically-treated stream(s) and the contaminant-diminished stream(s) (and, in some embodiments, any intermediate stream(s)) may have a temperature of about 25° C. or less, about 20° C. or less, about 15° C. or less, about 10° C. or less, about 5° C. or less, about 0° C. or less, or about −5° C. or less. In certain embodiments, the chemically-treated stream(s) and the contaminant-diminished stream(s) (and, in some embodiments, any intermediate streams) may have a temperature in the range of about −5° C. to about 0° C., about −5° C. to about 5° C., about −5° C. to about 10° C., about −5° C. to about 15° C., about −5° C. to about 20° C., or about −5° C. to about 25° C.

Certain methods described herein can be conducted at relatively high temperatures. In some embodiments, the chemically-treated stream(s) and the contaminant-diminished stream(s) (and, in some embodiments, any intermediate streams) may have a temperature of at least about 15° C., at least about 20° C., at least about 30° C., at least about 40° C., at least about 50° C., at least about 60° C., at least about 70° C., at least about 80° C., at least about 90° C., or at least about 100° C. In some embodiments, the chemically-treated stream(s) and the contaminant-diminished stream(s) (and, in some embodiments, any intermediate streams) may have a temperature in the range of about 15° C. to about 50° C., about 15° C. to about 80° C., about 15° C. to about 100° C., about 20° C. to about 50° C., about 20° C. to about 80° C., about 20° C. to about 100° C., about 50° C. to about 80° C., or about 50° C. to about 100° C.

In some embodiments, the residence time of an aqueous stream in water treatment systems described herein is relatively short. Those of ordinary skill in the art are capable of determining the residence time of a volume of fluid in a vessel. For a batch (i.e., non-flow) system, the residence time corresponds to the amount of time the fluid spends in the vessel. For a flow-based system, the residence time is determined by dividing the volume of the vessel by the volumetric flow rate of the fluid through the vessel.

In some embodiments, the residence time of a stream in the chemical coagulation apparatus is relatively short. In certain embodiments, the residence time of a stream in the chemical coagulation apparatus is about 1 hour or less, about 45 minutes or less, about 30 minutes or less, about 15 minutes or less, or about 10 minutes or less. In some embodiments, the residence time of a stream in the chemical coagulation apparatus is in the range of about 10 minutes to about 15 minutes, about 10 minutes to about 20 minutes, about 10 minutes to about 30 minutes, about 10 minutes to about 45 minutes, or about 10 minutes to about 1 hour.

In some embodiments, the residence time of a stream in the suspended solids removal apparatus is relatively short. In certain embodiments, the residence time of a stream in the suspended solids removal apparatus is about 1 hour or less, about 45 minutes or less, about 30 minutes or less, about 15 minutes or less, or about 10 minutes or less. In some embodiments, the residence time of a stream in the suspended solids removal apparatus is in the range of about 10 minutes to about 15 minutes, about 10 minutes to about 20 minutes, about 10 minutes to about 30 minutes, about 10 minutes to about 45 minutes, or about 10 minutes to about 1 hour.

In some embodiments, the residence time of a stream in the chemical coagulation apparatus and suspended solids removal apparatus is relatively short. In certain embodiments, the residence time of a stream in the chemical coagulation apparatus and suspended solids removal apparatus is about 1 hour or less, about 45 minutes or less, about 30 minutes or less, about 15 minutes or less, or about 10 minutes or less. In some embodiments, the residence time of a stream in the chemical coagulation apparatus and suspended solids removal apparatus is in the range of about 10 minutes to about 15 minutes, about 10 minutes to about 20 minutes, about 10 minutes to about 30 minutes, about 10 minutes to about 45 minutes, or about 10 minutes to about 1 hour.

In some embodiments, the residence time of a stream in the water treatment system is relatively short. In certain embodiments, the residence time of a stream in the water treatment system is about 1 hour or less, about 45 minutes or less, about 30 minutes or less, about 15 minutes or less, or about 10 minutes or less. In some embodiments, the residence time of a stream in the water treatment system is in the range of about 10 minutes to about 15 minutes, about 10 minutes to about 20 minutes, about 10 minutes to about 30 minutes, about 10 minutes to about 45 minutes, or about 10 minutes to about 1 hour.

According to some embodiments, the aqueous input stream comprises and/or is derived from produced water and/or flowback water. In some embodiments, the aqueous input stream comprises at least one suspended and/or emulsified immiscible phase (e.g., oil, grease). In certain cases, the aqueous input stream further comprises one or more additional contaminants. The one or more additional contaminants may include, but are not limited to, solubilized bicarbonate (HCO₃⁻) ions, solubilized divalent cations (e.g., Ca²⁺, Mg²⁺), solubilized trivalent cations (e.g., Fe³⁺, Al³⁺), organic material (e.g., humic acid, fulvic acid), hydrogen sulfide (H₂S), and suspended solids.

In some embodiments, the aqueous input stream comprises at least one suspended and/or emulsified immiscible phase. As used herein, a suspended and/or emulsified immiscible phase (e.g., a water-immiscible material) refers to a material that is not soluble in water to a level of more than 10% by weight at the temperature and under the conditions at which the chemical coagulation apparatus operates. In some embodiments, the suspended and/or emulsified immiscible phase comprises oil and/or grease. As used herein, the term “oil” refers to a fluid that is generally more hydrophobic than water and is not miscible or soluble in water, as is known in the art. Thus, the oil may be a hydrocarbon in some embodiments, but in other embodiments, the oil may comprise other hydrophobic fluids.

In some embodiments, the aqueous input stream has a relatively high concentration of at least one suspended and/or emulsified immiscible phase. In some embodiments, the aqueous input stream has a concentration of at least one suspended and/or emulsified immiscible phase of at least about 50 mg/L, at least about 75 mg/L, at least about 100 mg/L, at least about 125 mg/L, at least about 150 mg/L, at least about 175 mg/L, at least about 200 mg/L, at least about 250 mg/L, at least about 300 mg/L, at least about 350 mg/L, at least about 400 mg/L, at least about 450 mg/L, or at least about 500 mg/L. In some embodiments, the aqueous input stream has a concentration of at least one suspended and/or emulsified immiscible phase in the range of about 50 mg/L to about 100 mg/L, about 50 mg/L to about 150 mg/L, about 50 mg/L to about 200 mg/L, about 50 mg/L to about 250 mg/L, about 50 mg/L to about 300 mg/L, about 50 mg/L to about 350 mg/L, about 50 mg/L to about 400 mg/L, about 50 mg/L to about 450 mg/L, about 50 mg/L to about 500 mg/L, about 100 mg/L to about 150 mg/L, about 100 mg/L to about 200 mg/L, about 100 mg/L to about 250 mg/L, about 100 mg/L to about 300 mg/L, about 100 mg/L to about 350 mg/L, about 100 mg/L to about 400 mg/L, about 100 mg/L to about 450 mg/L, about 100 mg/L to about 500 mg/L, about 150 mg/L to about 200 mg/L, about 150 mg/L to about 250 mg/L, about 150 mg/L to about 300 mg/L, about 150 mg/L to about 350 mg/L, about 150 mg/L to about 400 mg/L, about 150 mg/L to about 450 mg/L, about 150 mg/L to about 500 mg/L, about 200 mg/L to about 300 mg/L, about 200 mg/L to about 350 mg/L, about 200 mg/L to about 400 mg/L, about 200 mg/L to about 450 mg/L, about 200 mg/L to about 500 mg/L, about 300 mg/L to about 400 mg/L, about 300 mg/L to about 500 mg/L, or about 400 mg/L to about 500 mg/L. One suitable method of measuring the concentration of a suspended and/or emulsified immiscible phase is using a Total Organic Carbon analyzer.

In some embodiments, the aqueous input stream comprises one or more dissolved salts. A dissolved salt is a salt that has been solubilized to such an extent that the component ions of the salt are no longer ionically bonded to each other. Accordingly, the aqueous input stream may comprise one or more solubilized ions.

In some embodiments, the one or more solubilized ions comprise solubilized monovalent cations (i.e., cations with a redox state of +1). Non-limiting examples of monovalent cations include Na⁺, K⁺, Li⁺, Rb⁺, Cs⁺, and Fr⁺. In some embodiments, the one or more solubilized ions comprise divalent cations (e.g., cations with a redox state of +2). Examples of divalent cations include, but are not limited to, Ca²⁺, Mg²⁺, Ba²⁺, and Sr²⁺. In some embodiments, the one or more solubilized cations comprise trivalent cations (i.e., cations with a redox state of +3). Non-limiting examples of trivalent cations include Fe³⁺ and Al³⁺. In some embodiments, the one or more solubilized ions comprise tetravalent cations (i.e., cations with a redox state of +4).

In some embodiments, the one or more solubilized ions include solubilized monovalent anions (i.e., anions with a redox state of −1). Non-limiting examples of monovalent anions include Cl⁻, Br⁻, and HCO₃⁻. In some embodiments, the one or more solubilized ions include solubilized divalent anions (i.e., anions with a redox state of −2). Non-limiting examples of divalent anions include SO₄²⁻ and CO₃²⁻.

In some embodiments, the aqueous input stream has a relatively high concentration of solubilized bicarbonate anions. In some embodiments, the bicarbonate ion concentration of the aqueous input stream is at least about 50 mg/L, at least about 100 mg/L, at least about 200 mg/L, at least about 300 mg/L, at least about 400 mg/L, at least about 500 mg/L, at least about 550 mg/L, at least about 600 mg/L, at least about 650 mg/L, at least about 700 mg/L, at least about 800 mg/L, at least about 900 mg/L, at least about 1000 mg/L, at least about 1500 mg/L, or at least about 2000 mg/L. In some embodiments, the bicarbonate ion concentration of the aqueous input stream is in the range of about 50 mg/L to about 100 mg/L, about 50 mg/L to about 200 mg/L, about 50 mg/L to about 300 mg/L, about 50 mg/L to about 400 mg/L, about 50 mg/L to about 500 mg/L, about 50 mg/L to about 600 mg/L, about 50 mg/L to about 700 mg/L, about 50 mg/L to about 800 mg/L, about 50 mg/L to about 900 mg/L, about 50 mg/L to about 1000 mg/L, about 50 mg/L to about 1500 mg/L, about 50 mg/L to about 2000 mg/L, about 100 mg/L to about 200 mg/L, about 100 mg/L to about 300 mg/L, about 100 mg/L to about 400 mg/L, about 100 mg/L to about 500 mg/L, about 100 mg/L to about 600 mg/L, about 100 mg/L to about 700 mg/L, about 100 mg/L to about 800 mg/L, about 100 mg/L to about 900 mg/L, about 100 mg/L to about 1000 mg/L, about 100 mg/L to about 1500 mg/L, about 100 mg/L to about 2000 mg/L, about 200 mg/L to about 300 mg/L, about 200 mg/L to about 400 mg/L, about 200 mg/L to about 500 mg/L, about 200 mg/L to about 600 mg/L, about 200 mg/L to about 700 mg/L, about 200 mg/L to about 800 mg/L, about 200 mg/L to about 900 mg/L, about 200 mg/L to about 1000 mg/L, about 200 mg/L to about 1500 mg/L, about 200 mg/L to about 2000 mg/L, about 300 mg/L to about 2000 mg/L, about 400 mg/L to about 2000 mg/L, about 500 mg/L to about 2000 mg/L, about 600 mg/L to about 2000 mg/L, about 700 mg/L to about 2000 mg/L, about 800 mg/L to about 2000 mg/L, about 900 mg/L to about 2000 mg/L, about 1000 mg/L to about 2000 mg/L, or about 1500 mg/L to about 2000 mg/L. The bicarbonate ion concentration is a property of the solution that may be determined according to any appropriate method known in the art, including inductively coupled plasma (ICP) spectroscopy (e.g., inductively coupled plasma optical emission spectroscopy). As one non-limiting example, an Optima 8300 ICP-OES spectrometer may be used.

In some embodiments, the aqueous input stream has a relatively high concentration of solubilized divalent cations (which may be collectively referred to as “hardness”). In some embodiments, the concentration of solubilized divalent cations in the aqueous input stream is at least about 500 mg/L, at least about 1000 mg/L, at least about 1500 mg/L, at least about 2000 mg/L, at least about 2500 mg/L, at least about 3000 mg/L, at least about 3500 mg/L, at least about 4000 mg/L, at least about 4500 mg/L, or at least about 5000 mg/L. In some embodiments, the concentration of solubilized divalent cations in the aqueous input stream is in the range of about 500 mg/L to about 1000 mg/L, about 500 mg/L to about 1500 mg/L, about 500 mg/L to about 2000 mg/L, about 500 mg/L to about 2500 mg/L, about 500 mg/L to about 3000 mg/L, about 500 mg/L to about 3500 mg/L, about 500 mg/L to about 4000 mg/L, about 500 mg/L to about 4500 mg/L, about 500 mg/L to about 5000 mg/L, about 1000 mg/L to about 1500 mg/L, about 1000 mg/L to about 2000 mg/L, about 1000 mg/L to about 2500 mg/L, about 1000 mg/L to about 3000 mg/L, about 1000 mg/L to about 3500 mg/L, about 1000 mg/L to about 4000 mg/L, about 1000 mg/L to about 4500 mg/L, about 1000 mg/L to about 5000 mg/L, about 2000 mg/L to about 2500 mg/L, about 2000 mg/L to about 3000 mg/L, about 2000 mg/L to about 3500 mg/L, about 2000 mg/L to about 4000 mg/L, about 2000 mg/L to about 4500 mg/L, about 2000 mg/L to about 5000 mg/L, about 3000 mg/L to about 3500 mg/L, about 3000 mg/L to about 4000 mg/L, about 3000 mg/L to about 4500 mg/L, about 3000 mg/L to about 5000 mg/L, or about 4000 mg/L to about 5000 mg/L. The divalent ion concentration is a property of the solution that may be determined according to any appropriate method known in the art, including ICP spectroscopy.

In some embodiments, the aqueous input stream has a relatively high total dissolved salt concentration. In some embodiments, the aqueous input stream has a total dissolved salt concentration of at least about 50,000 mg/L, at least about 75,000 mg/L, at least about 100,000 mg/L, at least about 125,000 mg/L, at least about 150,000 mg/L, at least about 175,000 mg/L, or at least about 200,000 mg/L. In some embodiments, the aqueous input stream has a total dissolved salt concentration in the range of about 50,000 mg/L to about 75,000 mg/L, about 50,000 mg/L to about 100,000 mg/L, about 50,000 mg/L to about 125,000 mg/L, about 50,000 mg/L to about 150,000 mg/L, about 50,000 mg/L to about 175,000 mg/L, about 50,000 mg/L to about 200,000 mg/L, about 100,000 mg/L to about 125,000 mg/L, about 100,000 mg/L to about 150,000 mg/L, about 100,000 mg/L to about 175,000 mg/L, or about 100,000 mg/L to about 200,000 mg/L. The total dissolved salt concentration generally refers to the combined concentrations of all the cations and anions of dissolved salts that are present. As a simple, non-limiting example, in a water stream comprising dissolved NaCl and dissolved MgSO₄, the total dissolved salt concentration would refer to the total concentrations of the Na⁻, Cl⁻, Mg²⁺, and SO₄²⁻ ions. Total dissolved salt concentration is a solution property that may be measured according to any appropriate method known in the art. For example, a suitable method for measuring total dissolved salt concentration is the SM 2540C method. According to the SM 2540C method, a sample comprising an amount of liquid comprising one or more dissolved solids is filtered (e.g., through a glass fiber filter), and the filtrate is evaporated to dryness in a weighed dish at 180° C. The increase in dish weight represents the mass of the total dissolved solids in the sample. The total dissolved salt concentration of the sample may be obtained by dividing the mass of the total dissolved solids by the volume of the original sample.

In some embodiments, the aqueous input stream has a relatively high total suspended solids concentration. The total suspended solids concentration of an aqueous stream as used herein refers to the total mass of solids retained by a filter per unit volume of the aqueous stream as measured using the SM 2540 D method. In some embodiments, the aqueous input stream has a total suspended solids concentration of at least about 500 mg/L, at least about 1000 mg/L, at least about 1500 mg/L, at least about 2000 mg/L, at least about 2500 mg/L, at least about 3000 mg/L, at least about 3500 mg/L, at least about 4000 mg/L, at least about 4500 mg/L, or at least about 5000 mg/L. In some embodiments, the total suspended solids concentration of the aqueous input stream is in the range of about 500 mg/L to about 1000 mg/L, about 500 mg/L to about 1500 mg/L, about 500 mg/L to about 2000 mg/L, about 500 mg/L to about 2500 mg/L, about 500 mg/L to about 3000 mg/L, about 500 mg/L to about 3500 mg/L, about 500 mg/L to about 4000 mg/L, about 500 mg/L to about 4500 mg/L, about 500 mg/L to about 5000 mg/L, about 1000 mg/L to about 1500 mg/L, about 1000 mg/L to about 2000 mg/L, about 1000 mg/L to about 2500 mg/L, about 1000 mg/L to about 3000 mg/L, about 1000 mg/L to about 3500 mg/L, about 1000 mg/L to about 4000 mg/L, about 1000 mg/L to about 4500 mg/L, about 1000 mg/L to about 5000 mg/L, about 2000 mg/L to about 2500 mg/L, about 2000 mg/L to about 3000 mg/L, about 2000 mg/L to about 3500 mg/L, about 2000 mg/L to about 4000 mg/L, about 2000 mg/L to about 4500 mg/L, about 2000 mg/L to about 5000 mg/L, about 3000 mg/L to about 3500 mg/L, about 3000 mg/L to about 4000 mg/L, about 3000 mg/L to about 4500 mg/L, about 3000 mg/L to about 5000 mg/L, or about 4000 mg/L to about 5000 mg/L.

In some embodiments, the aqueous input stream comprises hydrogen sulfide (H₂S). In certain cases, for example, hydrogen sulfide may be produced by certain kinds of bacteria (e.g., sulfate-reducing bacteria). In some embodiments, the concentration of hydrogen sulfide in the aqueous input stream is at least about 10 mg/L, at least about 20 mg/L, at least about 30 mg/L, at least about 40 mg/L, at least about 50 mg/L, or at least about 100 mg/L. In some embodiments, the hydrogen sulfide concentration of the aqueous input stream is in the range of about 10 mg/L to about 100 mg/L, about 20 mg/L to about 100 mg/L, about 30 mg/L to about 100 mg/L, about 40 mg/L to about 100 mg/L, or about 50 mg/L to about 100 mg/L.

In some embodiments, the aqueous input stream comprises organic matter (e.g., dissolved organic matter). In some cases, for example, the aqueous input stream comprises humic acid and/or fulvic acid. One measure of the amount of organic matter, including humic acid and/or fulvic acid, in an aqueous stream is the Pt—Co color value of the aqueous stream. In some embodiments, the aqueous input stream has a Pt—Co color value of at least about 100, at least about 250, at least about 500, at least about 750, at least about 1000, at least about 1250, or at least about 1500. In some embodiments, the aqueous input stream has a Pt—Co color value in the range of about 100 to about 1500, about 250 to about 1500, about 500 to about 1500, about 750 to about 1500, about 1000 to about 1500, or about 1250 to about 1500. The Pt—Co color value as used herein is determined according to ASTM Designation 1209, “Standard Test Method for Color of Clear Liquids (Platinum-Cobalt Scale).”

Certain systems and methods described herein may be used to treat an aqueous input stream comprising one or more contaminants to remove at least a portion of the one or more contaminants to produce a contaminant-diminished stream. In some embodiments, the contaminant-diminished stream contains a lower concentration of contaminants than the aqueous input stream.

In some embodiments, the chemical coagulation apparatus and suspended solids removal apparatus of a water treatment system are configured to remove a relatively large percentage of at least one suspended and/or emulsified immiscible phase from an aqueous input stream. In certain embodiments, for example, the concentration of at least one suspended and/or emulsified immiscible phase within a stream exiting the suspended solids removal apparatus (e.g., the contaminant-diminished stream) is at least about 50%, at least about 75%, at least about 90%, at least about 95%, or at least about 99% less than the concentration of the at least one suspended and/or emulsified immiscible phase within a stream entering the chemical coagulation apparatus (e.g., the aqueous input stream). In some embodiments, the percent difference between the concentration of the at least one suspended and/or emulsified immiscible phase in the aqueous input stream and the concentration of the at least one suspended and/or emulsified immiscible phase in the contaminant-diminished stream is in the range of about 50% to about 100%, about 75% to about 100%, about 90% to about 100%, about 95% to about 100%, or about 99% to about 100%.

According to some embodiments, the contaminant-diminished stream has a relatively low concentration of the at least one suspended and/or emulsified immiscible phase. In certain embodiments, the contaminant-diminished stream has a concentration of at least one suspended and/or emulsified immiscible phase of about 100 mg/L or less, about 90 mg/L or less, about 80 mg/L or less, about 70 mg/L or less, about 60 mg/L or less, about 50 mg/L or less, about 40 mg/L or less, about 30 mg/L or less, about 20 mg/L or less, about 15 mg/L or less, about 10 mg/L or less, about 5 mg/L or less, or about 1 mg/L or less. In some embodiments, the contaminant-diminished stream has a concentration of at least one suspended and/or emulsified immiscible phase in the range of about 0 mg/L to about 100 mg/L, about 0 mg/L to about 90 mg/L, about 0 mg/L to about 80 mg/L, about 0 mg/L to about 70 mg/L, about 0 mg/L to about 60 mg/L, about 0 mg/L to about 50 mg/L, about 0 mg/L to about 40 mg/L, about 0 mg/L to about 30 mg/L, about 0 mg/L to about 20 mg/L, about 0 mg/L to about 15 mg/L, about 0 mg/L to about 10 mg/L, about 0 mg/L to about 5 mg/L, or about 0 mg/L to about 1 mg/L. In some embodiments, the contaminant-diminished stream is substantially free of at least one suspended and/or emulsified immiscible phase.

In some embodiments, the chemical coagulation apparatus and suspended solids removal apparatus of a water treatment system are configured to remove a relatively large percentage of suspended solids from an aqueous input stream. In certain embodiments, for example, the total suspended solids concentration of a stream exiting the suspended solids removal apparatus (e.g., the contaminant-diminished stream) is at least about 50%, at least about 75%, at least about 90%, at least about 95%, or at least about 99% less than the total suspended solids concentration of a stream entering the chemical coagulation system (e.g., the aqueous input stream). In some embodiments, the percent difference between the total suspended solids concentration of the aqueous input stream and the total suspended solids concentration of the contaminant-diminished stream is in the range of about 50% to about 100%, about 75% to about 100%, about 90% to about 100%, about 95% to about 100%, or about 99% to about 100%.

According to some embodiments, the contaminant-diminished stream has a relatively low total suspended solids concentration. In certain embodiments, the contaminant-diminished stream has a total suspended solids concentration of about 100 mg/L or less, about 90 mg/L or less, about 80 mg/L or less, about 70 mg/L or less, about 60 mg/L or less, about 50 mg/L or less, about 40 mg/L or less, about 30 mg/L or less, about 20 mg/L or less, about 15 mg/L or less, about 10 mg/L or less, about 5 mg/L or less, or about 1 mg/L or less. In some embodiments, the contaminant-diminished stream has a total suspended solids concentration in the range of about 0 mg/L to about 100 mg/L, about 0 mg/L to about 90 mg/L, about 0 mg/L to about 80 mg/L, about 0 mg/L to about 70 mg/L, about 0 mg/L to about 60 mg/L, about 0 mg/L to about 50 mg/L, about 0 mg/L to about 40 mg/L, about 0 mg/L to about 30 mg/L, about 0 mg/L to about 20 mg/L, about 0 mg/L to about 15 mg/L, about 0 mg/L to about 10 mg/L, or about 0 mg/L to about 5 mg/L. In some embodiments, the contaminant-diminished stream is substantially free of suspended solids.

In some embodiments, the chemical coagulation apparatus and suspended solids removal apparatus of a water treatment system are configured to remove at least a portion of bicarbonate ions from an aqueous input stream. In certain embodiments, for example, the bicarbonate ion concentration of a stream exiting the suspended solids removal apparatus (e.g., the contaminant-diminished stream) is at least about 10%, at least about 20%, at least about 30%, at least about 40%, at least about 50%, at least about 60%, or at least about 75% less than the bicarbonate ion concentration of a stream entering the chemical coagulation apparatus (e.g., the aqueous input stream). In some embodiments, the percent difference between the bicarbonate ion concentration of the aqueous input stream and the bicarbonate ion concentration of the contaminant-diminished stream is in the range of about 50% to about 100%, about 75% to about 100%, about 90% to about 100%, about 95% to about 100%, or about 99% to about 100%.

According to some embodiments, the contaminant-diminished stream has a relatively low concentration of bicarbonate ions. In some embodiments, the contaminant-diminished stream has a bicarbonate ion concentration of about 500 mg/L or less, about 400 mg/L or less, about 300 mg/L or less, about 200 mg/L or less, about 100 mg/L or less, about 50 mg/L or less, or about 10 mg/L or less. In some embodiments, the contaminant-diminished stream has a bicarbonate ion concentration in the range of about 0 mg/L to about 500 mg/L, about 0 mg/L to about 400 mg/L, about 0 mg/L to about 300 mg/L, about 0 mg/L to about 200 mg/L, about 0 mg/L to about 100 mg/L, or about 0 mg/L to about 50 mg/L. In some embodiments, the contaminant-diminished stream is substantially free of bicarbonate ions.

In some embodiments, the chemical coagulation apparatus and suspended solids removal apparatus of a water treatment system are configured to remove at least a portion of divalent cations from an aqueous input stream. For example, the divalent cation concentration of a stream exiting the suspended solids removal apparatus (e.g., the contaminant-diminished stream) is at least about 5%, at least about 10%, at least about 20%, at least about 30%, at least about 40%, or at least about 50% less than the divalent cation concentration of a stream entering the chemical coagulation apparatus (e.g., the aqueous input stream). In some embodiments, the percent difference between the divalent cation concentration of the aqueous input stream and the divalent cation concentration of the contaminant-diminished stream is in the range of about 50% to about 100%, about 75% to about 100%, about 90% to about 100%, about 95% to about 100%, or about 99% to about 100%.

According to some embodiments, the contaminant-diminished stream has a divalent cation concentration of about 5000 mg/L or less, about 4000 mg/L or less, about 3000 mg/L or less, about 2000 mg/L or less, about 1000 mg/L or less, about 500 mg/L or less, or about 100 mg/L or less. In some embodiments, the contaminant-diminished stream has a divalent cation concentration in the range of about 0 mg/L to about 5000 mg/L, about 0 mg/L to about 400 mg/L, about 0 mg/L to about 300 mg/L, about 0 mg/L to about 200 mg/L, about 0 mg/L to about 100 mg/L, or about 0 mg/L to about 50 mg/L. In some embodiments, the contaminant-diminished stream is substantially free of divalent cations.

In some embodiments, the chemical coagulation apparatus and suspended solids removal apparatus of a water treatment system are configured to remove at least a portion of trivalent cations from an aqueous input stream. For example, the trivalent cation concentration of a stream exiting the suspended solids removal apparatus (e.g., the contaminant-diminished stream) is at least about 5%, at least about 10%, at least about 20%, at least about 30%, at least about 40%, or at least about 50% less than the trivalent cation concentration of a stream entering the chemical coagulation apparatus (e.g., the aqueous input stream). In some embodiments, the percent difference between the trivalent cation concentration of the aqueous input stream and the trivalent cation concentration of the contaminant-diminished stream is in the range of about 50% to about 100%, about 75% to about 100%, about 90% to about 100%, about 95% to about 100%, or about 99% to about 100%.

According to some embodiments, the contaminant-diminished stream has a trivalent cation concentration of about 5000 mg/L or less, about 4000 mg/L or less, about 3000 mg/L or less, about 2000 mg/L or less, about 1000 mg/L or less, about 500 mg/L or less, or about 100 mg/L or less. In some embodiments, the contaminant-diminished stream has a trivalent cation concentration in the range of about 0 mg/L to about 5000 mg/L, about 0 mg/L to about 400 mg/L, about 0 mg/L to about 300 mg/L, about 0 mg/L to about 200 mg/L, about 0 mg/L to about 100 mg/L, or about 0 mg/L to about 50 mg/L. In some embodiments, the contaminant-diminished stream is substantially free of trivalent cations.

In some embodiments, the chemical coagulation apparatus and suspended solids removal apparatus of a water treatment system are configured to remove a relatively large percentage of iron (e.g., dissolved iron ions) from an aqueous input stream. For example, the iron concentration of a stream exiting the suspended solids removal apparatus (e.g., the contaminant-diminished stream) is at least about 50%, at least about 75%, at least about 90%, at least about 95%, or at least about 99% less than the iron concentration of a stream entering the chemical coagulation apparatus (e.g., the aqueous input stream). In some embodiments, the percent difference between the iron concentration of the aqueous input stream and the iron concentration of the contaminant-diminished stream is in the range of about 50% to about 100%, about 75% to about 100%, about 90% to about 100%, about 95% to about 100%, or about 99% to about 100%.

According to some embodiments, the contaminant-diminished stream has an iron concentration of about 50 mg/L or less, about 40 mg/L or less, about 30 mg/L or less, about 20 mg/L or less, about 10 mg/L or less, about 5 mg/L or less, or about 1 mg/L or less. In some embodiments, the contaminant-diminished stream has an iron concentration in the range of about 0 mg/L to about 50 mg/L, about 0 mg/L to about 40 mg/L, about 0 mg/L to about 30 mg/L, about 0 mg/L to about 20 mg/L, about 0 mg/L to about 10 mg/L, or about 0 mg/L to about 5 mg/L. In some embodiments, the contaminant-diminished stream is substantially free of iron.

In some embodiments, the chemical coagulation apparatus and suspended solids removal apparatus of a water treatment system are configured to remove a relatively large percentage of hydrogen sulfide from an aqueous input stream. It may be desirable, in certain cases, to remove hydrogen sulfide from the aqueous input stream because hydrogen sulfide is highly toxic to humans. In some cases, removal of hydrogen sulfide through the chemical coagulation apparatus and the suspended solids removal apparatus may avoid or reduce the costs associated with alternative hydrogen-sulfide-removal methods and devices, such as gas strippers and/or activated carbon filters.

In some embodiments, the hydrogen sulfide concentration of a stream exiting the suspended solids removal apparatus (e.g., the contaminant-diminished stream) is at least about 50%, at least about 75%, at least about 90%, at least about 95%, or at least about 99% less than the hydrogen sulfide concentration of a stream entering the chemical coagulation apparatus (e.g., the aqueous input stream). In some embodiments, the percent difference between the hydrogen sulfide concentration of the aqueous input stream and the hydrogen sulfide concentration of the contaminant-diminished stream is in the range of about 50% to about 100%, about 75% to about 100%, about 90% to about 100%, about 95% to about 100%, or about 99% to about 100%.

According to some embodiments, the contaminant-diminished stream has a hydrogen sulfide concentration of about 50 mg/L or less, about 40 mg/L or less, about 30 mg/L or less, about 20 mg/L or less, about 10 mg/L or less, about 5 mg/L or less, or about 1 mg/L or less. In some embodiments, the contaminant-diminished stream has a hydrogen sulfide concentration in the range of about 0 mg/L to about 50 mg/L, about 0 mg/L to about 40 mg/L, about 0 mg/L to about 30 mg/L, about 0 mg/L to about 20 mg/L, about 0 mg/L to about 10 mg/L, or about 0 mg/L to about 5 mg/L. In some embodiments, the contaminant-diminished stream is substantially free of hydrogen sulfide.

In some embodiments, the chemical coagulation apparatus and suspended solids removal apparatus of a water treatment system are configured to remove a relatively large percentage of color (e.g., dissolved organic matter) from an aqueous input stream. In certain embodiments, for example, the Pt—Co color value of a stream exiting the suspended solids removal apparatus (e.g., the contaminant-diminished stream) is at least about 50%, at least about 75%, at least about 90%, at least about 95%, or at least about 99% less than the Pt—Co color value of a stream entering the chemical coagulation apparatus (e.g., the aqueous input stream). In some embodiments, the percent difference between the Pt—Co color value of the aqueous input stream and the Pt—Co color value of the contaminant-diminished stream is in the range of about 50% to about 100%, about 75% to about 100%, about 90% to about 100%, about 95% to about 100%, or about 99% to about 100%.

According to some embodiments, the contaminant-diminished stream has a Pt—Co color value of about 50 or less, about 40 or less, about 30 or less, about 20 or less, about 10 or less, about 5 or less, or about 1 or less. In some embodiments, the contaminant-diminished stream has Pt—Co color value in the range of about 0 to about 50, about 0 to about 40, about 0 mg/L to about 30, about 0 to about 20, about 0 to about 10, or about 0 to about 5. In some embodiments, the contaminant-diminished stream is substantially free of humic acid and/or fulvic acid.

According to some embodiments, the total dissolved salt concentration of the contaminant-diminished stream is not substantially higher than the total dissolved salt concentration of the aqueous input stream. In certain embodiments in which the contaminant-diminished stream has a higher total dissolved salt concentration than the aqueous input stream, the percent increase in total dissolved salt concentration is no more than about 10%, no more than about 5%, no more than about 2%, or no more than about 1%. In some embodiments, the percent increase is in the range of about 0% to about 1%, about 0% to about 2%, about 0% to about 5%, or about 0% to about 10%. In other embodiments, the contaminant-diminished stream has a lower total dissolved salt concentration than the aqueous input stream.

According to some embodiments, a water treatment system comprising a chemical coagulation apparatus and a suspended solids removal apparatus further comprises a desalination system. In some embodiments, the desalination system is configured to receive an aqueous stream comprising one or more dissolved salts from the suspended solids removal apparatus and to produce a substantially pure water stream lean in the one or more dissolved salts and a concentrated brine stream enriched in the one or more dissolved salts.

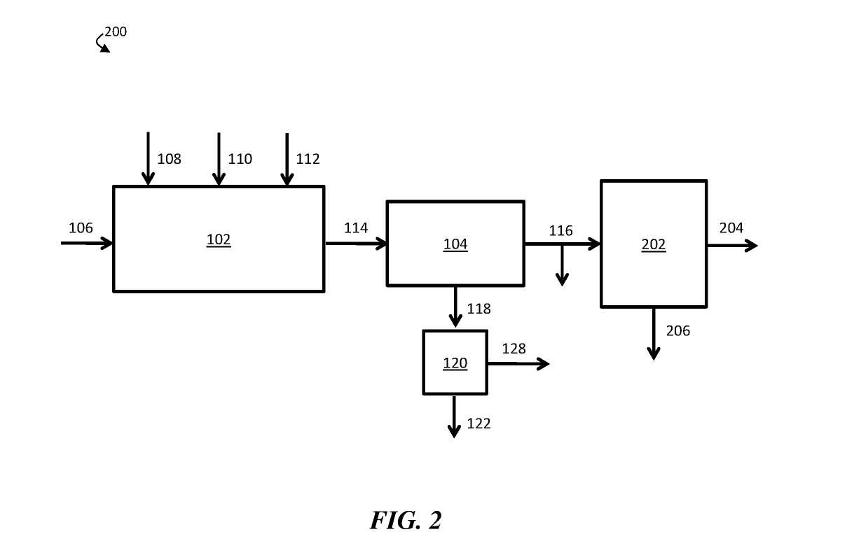

FIG. 2 shows a schematic diagram of an exemplary water treatment system 200 comprising chemical coagulation apparatus 102, suspended solids removal apparatus 104, optional solids-handling apparatus 120, and desalination system 202. As shown in FIG. 2, desalination system 202 is directly fluidically connected to suspended solids removal apparatus 104.

In operation, aqueous input stream 106, which may comprise one or more contaminants, may enter chemical coagulation apparatus 102, where inorganic coagulant 108, strong base 110, and polyelectrolyte 112 may be added to stream 106 to form chemically-treated stream 114. Chemically-treated stream 114, which may comprise a plurality of contaminant-comprising flocs, may then be directed to flow to suspended solids removal apparatus 104. In suspended solids removal apparatus 104, at least a portion of the plurality of flocs may settle to the bottom of apparatus 104, where they may be collected and discharged as solids-containing stream 118. In some embodiments, at least a portion of solids-containing stream 118 may be directed to flow to optional solids-handling apparatus 120, which may form filter cake 122 and filtered liquid stream 128.

The remainder of chemically-treated stream 114 may exit suspended solids removal apparatus 104 as contaminant-diminished stream 116. In certain embodiments, at least a portion of contaminant-diminished stream 116 may be discharged from water treatment system 200. In some embodiments, at least a portion of contaminant-diminished stream 116 may be directed to flow to desalination system 202. Desalination system 202 may remove at least a portion of at least one dissolved salt from contaminant-diminished stream 116 to produce substantially pure water stream 204, which has a lower concentration of the at least one dissolved salt than contaminant-diminished stream 116, and concentrated brine stream 206, which has a higher concentration of the at least one dissolved salt than contaminant-diminished stream 116.

In some embodiments, the desalination system is a thermal desalination system. According to certain embodiments, the desalination system is a humidification-dehumidification (HDH) desalination system. An HDH desalination system generally refers to a system comprising a humidifier and a dehumidifier. In some embodiments, the humidifier is configured to receive a liquid feed stream comprising water and at least one dissolved salt and to transfer at least a portion of the water from the liquid feed stream to a carrier gas through an evaporation process, thereby producing a humidified gas stream and a concentrated brine stream. In certain embodiments, the carrier gas comprises a non-condensable gas. Non-limiting examples of suitable non-condensable gases include air, nitrogen, oxygen, helium, argon, carbon monoxide, carbon dioxide, sulfur oxides (SOₓ) (e.g., SO₂, SO₃), and/or nitrogen oxides (NOₓ) (e.g., NO, NO₂). In some embodiments, the dehumidifier is configured to receive the humidified gas stream from the humidifier and to transfer at least a portion of the water from the humidified gas stream to a stream comprising substantially pure water through a condensation process.

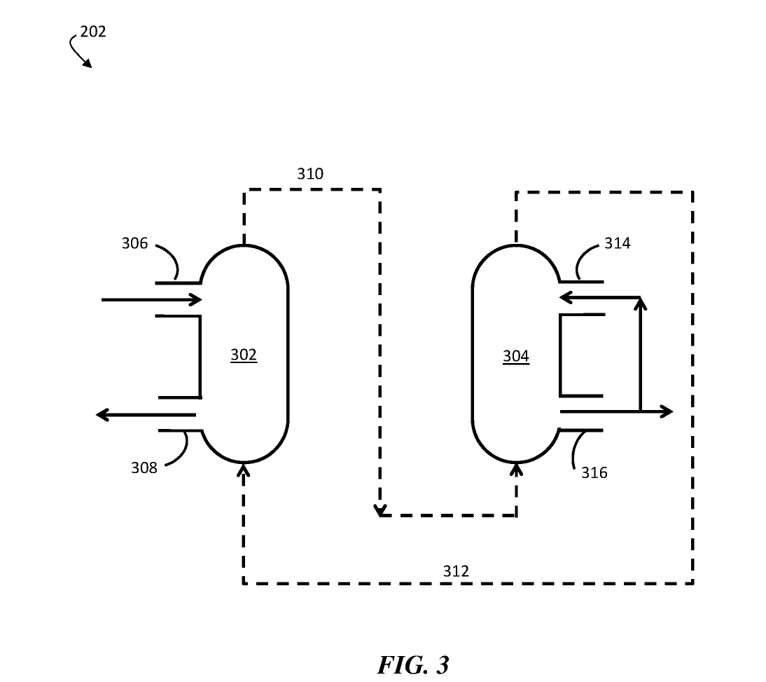

FIG. 3 shows a schematic illustration of an exemplary HDH desalination system 202, which may be used in association with certain inventive systems and methods described herein. In FIG. 3, desalination system 202 comprises humidifier 302 and dehumidifier 304. As shown in FIG. 3, humidifier 302 comprises liquid inlet 306 and liquid outlet 308. In FIG. 3, humidifier 302 is fluidically connected to dehumidifier 304 via gas conduits 310 and 312. As shown in FIG. 3, dehumidifier 304 comprises liquid inlet 314 and liquid outlet 316.

In operation, a liquid stream comprising water and a dissolved salt at an initial concentration may enter humidifier 302 through liquid inlet 306. Humidifier 302 may also be configured to receive a carrier gas stream comprising a non-condensable gas. According to some embodiments, humidifier 302 is configured such that the liquid stream comes into contact (e.g., direct or indirect contact) with the carrier gas stream, and heat and water vapor are transferred from the liquid stream to the carrier gas stream through an evaporation process, thereby producing a humidified gas stream. In some embodiments, the remaining portion of the liquid stream that is not transported to the carrier gas stream forms a concentrated brine stream enriched in the dissolved salt relative to the liquid stream (e.g., the concentration of the dissolved salt in the concentrated brine stream is greater than the initial concentration of the dissolved salt in the liquid stream). In some embodiments, the concentrated brine stream exits humidifier 302 through liquid outlet 308.

According to some embodiments, the humidified gas stream exits humidifier 302 and flows through gas conduit 310 to dehumidifier 304. A stream comprising substantially pure water may enter dehumidifier 304 through liquid inlet 314. In dehumidifier 304, the humidified gas stream may come into contact (e.g., direct or indirect contact) with the substantially pure water stream, and heat and water may be transferred from the humidified gas stream to the substantially pure water stream through a condensation process, thereby producing a dehumidified gas stream. The stream comprising substantially pure water may exit dehumidifier 304 through liquid outlet 316; in some cases, at least a portion of the substantially pure water stream may be discharged from HDH desalination system 202, and at least a portion of the substantially pure water stream may be recirculated to liquid inlet 314. The dehumidified gas stream may exit dehumidifier 304, and at least a portion of the dehumidified gas stream may flow to humidifier 302 through gas conduit 312. In some embodiments, at least a portion of the dehumidified gas stream may be transported elsewhere within the system and/or vented.

The humidifier may have any configuration that allows for the transfer of water vapor from a liquid feed stream to a carrier gas stream (e.g., through an evaporation process). In certain embodiments, the humidifier comprises a vessel (e.g., a stainless steel tank, a fiber-reinforced plastic tank, or other vessel). The humidifier vessel can comprise a liquid inlet configured to receive a liquid feed stream comprising water and at least one dissolved salt and a gas inlet configured to receive a carrier gas stream. In some embodiments, the humidifier can further comprise a liquid outlet and a gas outlet.

The dehumidifier may have any configuration that allows for the transfer of water from a humidified gas stream to a stream comprising substantially pure water (e.g., through a condensation process). In certain embodiments, the dehumidifier comprises a vessel (e.g., a stainless steel tank, a fiber-reinforced plastic tank, or other vessel). The dehumidifier vessel can comprise a liquid inlet configured to receive a stream comprising substantially pure water and a gas inlet configured to receive the humidified gas stream. In some embodiments, the dehumidifier can further comprise a liquid outlet for the stream comprising substantially pure water and a gas outlet for the dehumidified gas stream.

According to some embodiments, the humidifier is a bubble column humidifier (i.e., a humidifier in which the evaporation process occurs through direct contact between a liquid feed stream and bubbles of a carrier gas) and/or the dehumidifier is a bubble column dehumidifier (i.e., a dehumidifier in which the condensation process occurs through direct contact between a substantially pure liquid stream and bubbles of a humidified gas). In some cases, bubble column humidifiers and bubble column dehumidifiers may be associated with certain advantages. For example, bubble column humidifiers and dehumidifiers may exhibit higher thermodynamic effectiveness than certain other types of humidifiers (e.g., packed bed humidifiers, spray towers, wetted wall towers) and dehumidifiers (e.g., surface condensers). Without wishing to be bound by a particular theory, the increased thermodynamic effectiveness may be at least partially attributed to the use of gas bubbles for heat and mass transfer in bubble column humidifiers and dehumidifiers, since gas bubbles may have more surface area available for heat and mass transfer than many other types of surfaces (e.g., metallic tubes, liquid films, packing material). In addition, bubble column humidifiers and dehumidifiers may have certain features that further increase thermodynamic effectiveness, including, but not limited to, relatively low liquid level height, relatively high aspect ratio liquid flow paths, and multi-staged designs.

In certain embodiments, a bubble column humidifier comprises at least one stage comprising a chamber and a liquid layer positioned within a portion of the chamber. The liquid layer may, in some cases, comprise a liquid comprising water and at least one dissolved salt. The chamber may further comprise a gas distribution region occupying at least a portion of the chamber not occupied by the liquid layer. In addition, the chamber may be in fluid communication with a bubble generator (e.g., a sparger plate). In some embodiments, a carrier gas stream flows through the bubble generator, forming bubbles of the carrier gas. The carrier gas bubbles may then travel through the liquid layer. The liquid layer may be maintained at a temperature higher than the temperature of the gas bubbles, and as the gas bubbles directly contact the liquid layer, heat and/or mass may be transferred from the liquid layer to the gas bubbles. In some cases, at least a portion of water may be transferred to the gas bubbles through an evaporation process. The bubbles of the humidified gas may exit the liquid layer and enter the gas distribution region. The humidified gas may be substantially homogeneously distributed throughout the gas distribution region. The humidified gas may then exit the bubble column humidifier as a humidified gas stream.

In some embodiments, a bubble column dehumidifier comprises at least one stage comprising a chamber and a liquid layer positioned within a portion of the chamber. The liquid layer may, in some cases, comprise substantially pure water. The chamber may further comprise a gas distribution region occupying at least a portion of the chamber not occupied by the liquid layer. In addition, the chamber may be in fluid communication with a bubble generator (e.g., a sparger plate). In some embodiments, the humidified gas stream flows from the humidifier through the bubble generator, forming bubbles of the humidified gas. The bubbles of the humidified gas may then travel through the liquid layer. The liquid layer may be maintained at a temperature lower than the temperature of the humidified gas bubbles, and as the humidified gas bubbles directly contact the liquid layer, heat and/or mass may be transferred from the humidified gas bubbles to the liquid layer via a condensation process.

Suitable bubble column condensers that may be used as the dehumidifier and/or suitable bubble column humidifiers that may be used as the humidifier in certain systems and methods described herein include those described in U.S. Pat. No. 8,523,985, by Govindan et al., issued Sep. 3, 2013, and entitled “Bubble-Column Vapor Mixture Condenser”; U.S. Pat. No. 8,778,065, by Govindan et al., issued Jul. 15, 2014, and entitled “Humidification-Dehumidification System Including a Bubble-Column Vapor Mixture Condenser”; U.S. Pat. No. 9,072,984, by Govindan et al., issued Jul. 7, 2015, and entitled “Bubble-Column Vapor Mixture Condenser”; U.S. Pat. No. 9,120,033, by Govindan et al., issued Sep. 1, 2015, and entitled “Multi-Stage Bubble Column Humidifier”; U.S. Pat. No. 9,266,748, by Govindan et al., issued Feb. 23, 2016, and entitled “Transiently-Operated Desalination Systems with Heat Recovery and Associated Methods”; U.S. Patent Publication No. 2016/0229705, by St. John et al., filed May 21, 2015, and entitled “Methods and Systems for Producing Treated Brines for Desalination”; U.S. Patent Publication No. 2016/0228795, by St. John et al., filed May 21, 2015, and entitled “Methods and Systems for Producing Treated Brines”; U.S. Patent Publication No. 2015/0083577, by Govindan et al., filed Sep. 23, 2014, and entitled “Desalination Systems and Associated Methods”; U.S. Patent Publication No. 2015/0129410, by Govindan et al., filed Sep. 12, 2014, and entitled “Systems Including a Condensing Apparatus Such as a Bubble Column Condenser”; U.S. patent application Ser. No. 14/718,483, by Govindan et al., filed May 21, 2015, and entitled “Systems Including an Apparatus Comprising both a Humidification Region and a Dehumidification Region”; U.S. patent application Ser. No. 14/718,510, by Govindan et al., filed May 21, 2015, and entitled “Systems Including an Apparatus Comprising both a Humidification Region and a Dehumidification Region with Heat Recovery and/or Intermediate Injection”; and U.S. patent application Ser. No. 14/719,239, by Govindan et al., filed May 21, 2015, and entitled “Transiently-Operated Desalination Systems and Associated Methods,” each of which is incorporated herein by reference in its entirety for all purposes.

According to certain embodiments, the water treatment system further comprises an optional generator. The generator may, for example, provide electrical power and/or heat to one or more components of the water treatment system. In some embodiments, the generator is in electrical communication with a chemical coagulation apparatus and/or a suspended solids removal apparatus of the system. However, while producing electrical power, the generator may also produce heat. If the heat is removed from the generator and released to the environment as waste heat, the waste heat may represent a significant energy loss. Further, if the heat is removed from the generator using one or more fans and/or one or more cooling devices (e.g., a device comprising a cooling jacket and a thermal storage fluid), heat removal may require additional energy input and/or additional materials and system components. In some cases, however, heat produced by the generator may instead be recovered and utilized. According to some embodiments, at least a portion of the heat produced by the generator may be transferred to a heat transfer fluid and, subsequently, to one or more chemicals used in connection with the chemical coagulation apparatus.

Any type of generator known in the art may be used. Examples of suitable generators include, but are not limited to, gas-turbine-powered electrical generators and internal combustion electrical generators (e.g., gensets). The generator may be configured to consume a fuel such as natural gas, diesel, propane, kerosene, gasoline, and/or a biofuel. In some embodiments, the generator may be capable of producing at least about 100 kW, at least about 250 kW, at least about 500 kW, at least about 750 kW, at least about 1 MW, at least about 2 MW, at least about 5 MW, or at least about 10 MW of electrical power. In some embodiments, the generator may be capable of producing electrical power in the range of about 100 kW to about 500 kW, about 100 kW to about 1 MW, about 100 kW to about 2 MW, about 100 kW to about 5 MW, about 100 kW to about 10 MW, about 500 kW to about 1 MW, about 500 kW to about 2 MW, about 500 kW to about 5 MW, about 500 kW to about 10 MW, about 1 MW to about 5 MW, about 1 MW to about 10 MW, or about 5 MW to about 10 MW.

In some embodiments, the system may comprise a plurality of generators. The generators of the plurality of the generators may be the same or different types of generators. In some cases, at least two of the plurality of generators may be arranged in series and/or in parallel.

In certain embodiments, the water treatment system further comprises a heat exchanger. The heat exchanger may be any type of heat exchanger known in the art. Examples of suitable heat exchangers include, but are not limited to, plate-and-frame heat exchangers, shell-and-tube heat exchangers, tube-and-tube heat exchangers, plate heat exchangers, plate-and-shell heat exchangers, and the like. The heat exchanger may be configured such that a first fluid stream and a second fluid stream flow through the heat exchanger. In some cases, the first fluid stream and the second fluid stream may flow in substantially the same direction (e.g., parallel flow), substantially opposite directions (e.g., counter flow), or substantially perpendicular directions (e.g., cross flow). In certain embodiments, one or more chemicals used in connection with a component of the water treatment system (e.g., an inorganic coagulant, a strong base, a polyelectrolyte) may flow through a first side of the heat exchanger. In some embodiments, a heat transfer fluid may flow through a second side of the heat exchanger. In certain cases, heat produced by the generator may be used to heat the heat transfer fluid. Within the heat exchanger, heat may be transferred from the heat transfer fluid to one or more chemicals used in connection with a component of the water treatment system. In some cases, this use of heat from the generator may avoid or reduce costs associated with heating the one or more chemicals to an appropriate temperature, for example during cold weather. In some cases, this use of heat may be particularly useful for off-grid systems.

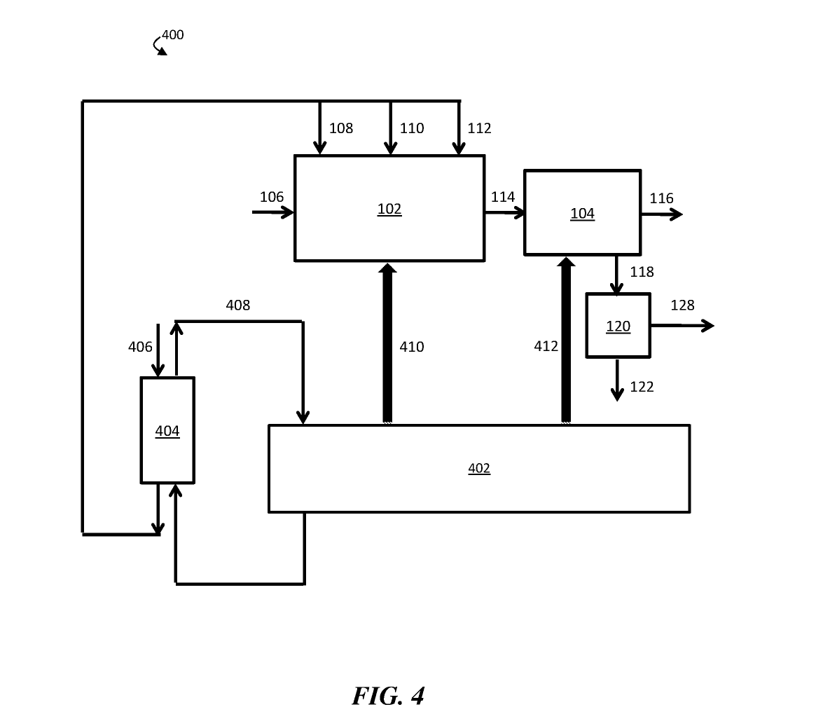

FIG. 4 shows an exemplary schematic illustration of a system 400 comprising chemical coagulation apparatus 102, suspended solids removal apparatus 104, optional solids-handling apparatus 120, generator 402, and heat exchanger 404. As shown in FIG. 4, generator 402 is in electrical communication with chemical coagulation apparatus 102 (e.g., via electrical wiring). Generator 402 is also in electrical communication with suspended solids removal apparatus 104.

In operation, electrical power 410 may be transferred from generator 402 to chemical coagulation apparatus 102. In addition, electrical power 412 may be transferred from generator 402 to suspended solids removal apparatus 104. Generator 402 may also transfer heat to heat transfer fluid 408, which may flow through one side of heat exchanger 404 (e.g., in a first direction). In some cases, at least a portion of inorganic coagulant 108, strong base 110, and/or polyelectrolyte 112 may flow through a second side of heat exchanger 404 (e.g., in a second, substantially opposite direction). In some embodiments, heat may be transferred from heat transfer fluid 408 to inorganic coagulant 108, strong base 110, and/or polyelectrolyte 112 within heat exchanger 404.

### Example 1

In this example, a water treatment system comprising a chemical coagulation apparatus and a suspended solids removal apparatus was used to treat produced water from Tarzan, Tex. A continuous water treatment system was simulated by performing each constituent process step as a batch operation on a 1000 mL sample of raw wastewater. In the water treatment system, an inorganic coagulant comprising aluminum chlorohydrate was first added to a feed stream, a strong base comprising caustic soda (e.g., sodium hydroxide) was then added, and a polyelectrolyte comprising anionic polyacrylamide was subsequently added in order to produce a chemically-treated sample. Suspended solids were separated gravimetrically from the chemically-treated sample, then dewatered by positive pressure filtration. Table 1 lists the concentrations of various constituents of the aqueous input stream (raw wastewater sample—Stream 1) and the treated, contaminant-diminished stream (Stream 5).

TABLE 1
Analysis of Raw and Treated Wastewater Samples

| | RAW | TREATED |
|---|---|---|
| | SAMPLE | STREAM |
| PROPERTY | (STREAM 1) | (STREAM 5) |
| Specific Gravity [—] | 1.076 | 1.076 |
| pH [STD units] | 7.2 | 8 |
| Bicarbonate Alkalinity [mg/L] | 695 | 390 |
| Calcium [mg/L] | 3,240 | 2,960 |
| Magnesium [mg/L] | 316 | 219 |
| Sodium [mg/L] | 41,228 | 40,276 |
| Sulfate [mg/L] | 334 | 416 |
| Chloride [mg/L] | 69,580 | 67,450 |
| Iron [mg/L] | 21 | 1 |
| Total Dissolved Solids [mg/L] | 115,398 | 111,711 |
| Hydrogen Sulfide [mg/L] | 37 | 0 |
| Total Suspended Solids [mg/L] | 810 | 10 |
| Oil & Grease [mg/L] | 121 | 4 |
| Color (Pt—Co units) | >500 | 15 |

FIG. 1C is a schematic diagram of the water treatment system that this experiment was designed to simulate. The system comprises chemical coagulation apparatus 102, suspended solids removal apparatus 104, and solids-handling apparatus 120. Influent stream 106 is flowed to coagulation apparatus 102 to become chemically-treated stream 114. Chemically-treated stream 114 is flowed to suspended solids removal apparatus 104 in which suspended solids are removed to produce contaminant-diminished stream 116 and solids-containing stream 118. Solids-containing stream 118 is flowed to solids-handling apparatus 120 in which solid content is further separated from liquid content to produce filter cake 122 and filtered liquid stream 128.

In the experiment described in this example, a beaker and magnetic stirrer were used to simulate chemical coagulation apparatus 102 and to produce a chemically-treated sample from the sample of raw wastewater. A settling rate experiment was performed on the chemically-treated sample in order to simulate the performance of suspended solids removal apparatus 104. The supernatant from the settling rate experiment was decanted, producing a contaminant-diminished sample and a solids-containing sample. The solids-containing sample was dewatered in a LAROX PF 0.01 H2 laboratory pressure filter to simulate solids-handling apparatus 120, producing a filter cake sample and a filtrate sample.

The three reaction vessels of the system shown in FIG. 1C were simulated as three separate chemical additions to a stirred beaker, after each of which 75 seconds was allowed to pass, reflecting the residence time of water in those vessels at the designed flow rate. A coagulant consisting of a 50% by weight solution of aluminum chlorohydrate, an inorganic cationic polymer, was added first. Selected properties of this coagulant are shown in Table 2 below.

TABLE 2
Coagulant properties

| Property | Value | Units |
|---|---|---|
| Basicity | 83.77% | — |
| % Aluminum | 12.39% | — |
| Specific Gravity at 60° F. | 1.3388 | — |

After the passage of 75 seconds, a strong base was added. This strong base consisted of a 50% by weight solution of sodium hydroxide. The strong base was added incrementally until the pH of the sample reached 8.

Following this step, a polyelectrolyte flocculant was added. The polyelectrolyte flocculant was prepared by dissolving SUPERFLOC® A-130 in water at a 0.1% concentration to produce an anionic polymer solution. Selected properties of the polyelectrolyte flocculant are listed in Table 3.

TABLE 3
Flocculant Properties

| Property | Value | Units |
|---|---|---|
| Molecular Weight | 10-15 | MDa |
| Monomers | Acrylamide, Sodium Acrylate | — |

After the addition of the polyelectrolyte flocculant, flocculation was enhanced by reducing the mixing rate to the slowest rate at which floc suspension could be maintained. This reduced rate of stirring was maintained for 30 minutes, simulating the average residence time of fluid in reaction vessel 102C of the designed system.

To measure the settling rate of the flocs in the sample, it was transferred to a graduated cylinder. As the flocs settled to the bottom, the position of the top of the sludge blanket and a corresponding time were recorded every few seconds. The surface loading rate was calculated from this measurement and found to be well above 0.25 gpm/ft².

The supernatant of the settling rate experiment was decanted and analyzed for concentrations of constituent contaminants. These contaminants are reported in Table 1 above. The settled solids were dewatered in a LAROX PF 0.01 H2 laboratory pressure filter.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method for treating water, comprising:
supplying an aqueous input stream comprising at least one suspended and/or emulsified immiscible phase to a chemical coagulation apparatus;
adding, within the chemical coagulation apparatus, an amount of an inorganic coagulant, an amount of a strong base, and an amount of a polyelectrolyte to the aqueous input stream to form a chemically-treated stream; and
flowing the chemically-treated stream to a suspended solids removal apparatus configured to remove at least a portion of suspended solids from the chemically-treated stream to form a contaminant-diminished stream,
wherein each of the chemically-treated stream and the contaminant-diminished stream has a pH of about 8 or less.

2. A method for treating water, comprising:
supplying an aqueous input stream comprising at least one suspended and/or emulsified immiscible phase to a chemical coagulation apparatus;
adding, within the chemical coagulation apparatus, an amount of an inorganic coagulant, an amount of a strong base, and an amount of a polyelectrolyte to the aqueous input stream to form a chemically-treated stream; and
flowing the chemically-treated stream to a suspended solids removal apparatus configured to remove at least a portion of suspended solids from the chemically-treated stream to form a contaminant-diminished stream,
wherein each of the chemically-treated stream and the contaminant-diminished stream has a temperature of about 15° C. or less.

3-5. (canceled)

6. The method of claim 1, wherein the inorganic coagulant is a cationic inorganic polymer.

7. The method of claim 1, wherein the inorganic coagulant has a basicity of at least about 50%.

8. The method of claim 1, wherein the inorganic coagulant has a number average molecular weight from about 200 g/mol to about 800 g/mol.

9. (canceled)

10. The method of claim 1, wherein the inorganic coagulant comprises aluminum.

11-13. (canceled)

14. The method of claim 1, wherein the polyelectrolyte is anionic or nonionic.

15. The method of claim 1, wherein the polyelectrolyte has a molecular weight in the range of about 10,000 g/mol to about 30,000,000 g/mol.

16. The method of claim 1, wherein the polyelectrolyte comprises anionic polyacrylamide.

17. (canceled)

18. The method of claim 1, wherein the suspended solids removal apparatus is a gravity-based settling apparatus.

19-20. (canceled)

21. The method of claim 1, wherein the suspended solids removal apparatus produces about 0.25 kg or less of the solids-containing stream per barrel produced of the contaminant-diminished stream.

22. The method of claim 1, further comprising flowing the solids-containing stream to a solids-handling apparatus, wherein the solids-handling apparatus comprises a filter press, a vacuum filter, and/or a centrifuge.

23. The method of claim 1, further comprising flowing at least a portion of the contaminant-diminished stream to a desalination system.

24. The method of claim 23, wherein the desalination system is a humidification-dehumidification desalination system.

25-35. (canceled)

36. The method of claim 1, wherein the aqueous input stream has a total suspended solids concentration of at least about 500 mg/L.

37. (canceled)

38. The method of claim 1, wherein the aqueous input stream comprises humic acid and/or fulvic acid.

39. The method of claim 1, wherein the aqueous input stream has a Pt—Co color value of at least about 500.

40. The method of claim 1, wherein a total suspended solids concentration within the contaminant-diminished stream is at least about 50% less than a total suspended solids concentration within the aqueous input stream.

41-48. (canceled)

49. The method of claim 1, wherein the contaminant-diminished stream has a Pt—Co color value of about 50 or less.

50. The method of claim 1, wherein the residence time of the aqueous input stream in the chemical coagulation apparatus and the suspended solids removal apparatus is about 1 hour or less.
